(19) United States
(12) Patent Application Publication
(10) Pub. No.: US 2011/0040930 A1
(43) Pub. Date: Feb. 17, 2011

(54) Method for Accessing Flash Memory Device and Memory System Including the Same

(76) Inventors: Heedong Shin, Seoul (KR); Sanghyun Park, Hwaseong-si (KR); Bong-Chun Kang, Siheung-si (KR); Jihyun In, Seongnam-si (KR); HyungSeok Park, Seoul (KR)

Correspondence Address: MYERS BIGEL SIBLEY & SAJOVEC, PO BOX 37428, RALEIGH, NC, 27627, US

(21) Appl. No.: 12/848,394

(22) Filed: Aug. 2, 2010

(30) Foreign Application Priority Data
Aug. 17, 2009 (KR) 10-2009-0075802

(51) Int. Cl. G06F 12/00; G06F 12/02

(52) U.S. Cl. 711/103; 711/E12.001; 711/E12.008

(57) ABSTRACT

Provided are a method for accessing a flash memory device and a memory system including the same. In the method, first and second storage regions of a memory block of the flash memory device are set to free blocks, and each of the first and second storage regions are set to a data block independently.

### REFERENCE TO RELATED APPLICATION

This application claims priority to Korean Patent Application No. 10-2009-0075802, filed Aug. 17, 2009, the contents of which are hereby incorporated by reference.

### FIELD OF THE INVENTION

The present application relates to semiconductor memory devices and, more particularly, to methods for accessing flash memory devices and memory systems including the same.

### BACKGROUND

Semiconductor memory devices are memory devices that are implemented using a semiconductor such as silicon (Si), germanium (Ge), gallium arsenide (GaAs) and indium phosphide (InP). The semiconductor memory devices are classified into volatile memory devices and nonvolatile memory devices.

The volatile memory devices lose data stored therein when power supply thereto is interrupted. Examples of the volatile memory devices include static random access memory (SRAM) devices, dynamic random access memory (DRAM) devices, and synchronous dynamic random access memory (SDRAM) devices. The nonvolatile memory devices retain data stored therein even when power supply thereto is interrupted. Examples of the nonvolatile memory devices include read-only memory (ROM) devices, programmable read-only memory (PROM) devices, erasable programmable read-only memory (EPROM) devices, electrically erasable programmable read-only memory (EEPROM) devices, flash memory devices, phase-change random access memory (PRAM) devices, magnetic random access memory (MRAM) devices, resistive random access memory (RRAM) devices, and ferroelectric random access memory (FRAM) devices. The flash memory devices are classified into NOR-type flash memory devices and NAND-type flash memory devices.

### SUMMARY

Embodiments of the inventive concept provide a method for accessing a flash memory device with an improved operation speed and a memory system including the same.

In some embodiments of the inventive concept, methods for accessing a flash memory device include: setting first and second storage regions of a memory block of the flash memory device to free blocks; and setting each of the first and second storage regions to a data block independently.

In some embodiments, the setting of the first and second storage regions to a data block independently includes setting the first and second storage regions to a log block independently.

In other embodiments, the first and second storage regions of the memory block are simultaneously erased in an erase operation.

In further embodiments, the first storage region is program-inhibited when the second storage region is set to a data block.

In still further embodiments, the second storage region is set to a data block when the first storage region is a data block including a free capacity.

In still further embodiments, the methods further include setting the free capacity of the first storage region to a programmed capacity.

In other embodiments of the inventive concept, memory systems include: a flash memory device including a plurality of memory blocks; and a controller configured to control the flash memory device, wherein the controller sets each of the first and second storage regions of each of the memory blocks to one of a free block and a data block independently.

In some embodiments, the controller erases the flash memory device by the memory block.

In other embodiments, the controller selects the second storage region of the memory block corresponding to a first condition among the memory blocks when selecting a free block to be programmed with data; and the first storage region of the memory block corresponding to the first condition is one of a full block and an invalid block and the second storage region is a free block.

In further embodiments, the controller selects the first storage region of the memory block corresponding to a second condition among the memory blocks when selecting a free block to be programmed with data; and the first and second storage regions of the memory block corresponding to the second condition are free blocks.

In still further embodiments, the controller selects the second storage region of the memory block corresponding to a third condition among the memory blocks when selecting a free block to be programmed with data; and the first storage region of the memory block corresponding to the third condition includes a free capacity and the second storage region is a free block.

In still further embodiments, the controller sets the free capacity of the first storage region of the memory block corresponding to the third condition to a programmed capacity.

In still further embodiments, when the second, storage region of one of the memory blocks is set to a data block, the controller sets the first storage region of the one of the memory blocks to a program inhibition block.

In still further embodiments, when the update frequency of specific data is greater than a predetermined value, the controller sets the first and second storage regions of the memory block corresponding to a fourth condition among the memory blocks to a random sequence block and copies the specific data into the random sequence block; and the first and second storage regions of the memory block corresponding to the fourth condition are free blocks.

In still further embodiments, when first data programmed in one of the first storage regions of the memory cells are updated into second data, the controller sets the one of the first storage regions and the second storage region corresponding to the one of the first storage regions to a random sequence block and programs the second data in the random sequence block.

In still further embodiments, the controller sets the first and second storage regions of one of the memory blocks, which stores a file system, to a random sequence block.

In still further embodiments, the controller sets each of the first and second storage regions of each of the memory blocks to a log block independently.

In still further embodiments, the flash memory device and the controller constitute a solid state drive (SSD).

In still further embodiments, the memory systems further include a user interface configured to exchange information with a user.

In further embodiments of the inventive concept, memory systems include: a flash memory device including a plurality of memory blocks; and a controller configured to control the flash memory device, wherein the controller divides each of the memory blocks into at least two sub storage regions and sets each of the sub storage regions to one of a free block and a data block independently.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a memory system according to an embodiment of the inventive concept;

FIG. 2 is a block diagram illustrating a method for a flash translation layer (FTL) of FIG. 1 to control a flash memory device;

FIG. 3 is a flow chart illustrating the operations of a host, an FTL and a flash memory device;

FIG. 4 is a flow chart illustrating an update process of FIG. 3;

FIGS. 5A and 5B are flow charts illustrating a method for setting a free block to a data block or a log block in FIGS. 3 and 4;

FIGS. 6 to 11 are block diagrams illustrating a method for an FTL to perform a block setting operation according to a block setting method described with reference to FIGS. 3 to 5;

FIGS. 12A and 12B are block diagrams illustrating an embodiment of setting a data block according to a second condition;

FIGS. 13A and 13B are block diagrams illustrating an embodiment of setting a data block according to first and second conditions;

FIG. 14 is a block diagram illustrating another embodiment of the FTL of FIG. 2;

FIG. 15 is a flow chart illustrating an embodiment 1 of an operation method of the FTL of FIG. 14;

FIGS. 16 to 18 are block diagrams illustrating an embodiment of an operation method described with reference to FIG. 15;

FIG. 19 is a flow chart illustrating an embodiment 2 of an operation method of the FTL of FIG. 14;

FIGS. 20 and 21 are block diagrams illustrating an embodiment of an operation method described with reference to FIG. 19;

FIG. 22 is a flow chart illustrating an embodiment 3 of an operation method of the FTL of FIG. 14;

FIG. 23 is a block diagram illustrating a flash memory device of FIG. 1;

FIG. 24 is a block diagram illustrating an embodiment 2 of the memory system of FIG. 1;

FIG. 25 is a block diagram illustrating an embodiment 3 of the memory system of FIG. 1; and

FIG. 26 is a block diagram of a computing system including the memory system of FIG. 25.

### DETAILED DESCRIPTION OF THE EMBODIMENTS

Preferred embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout.

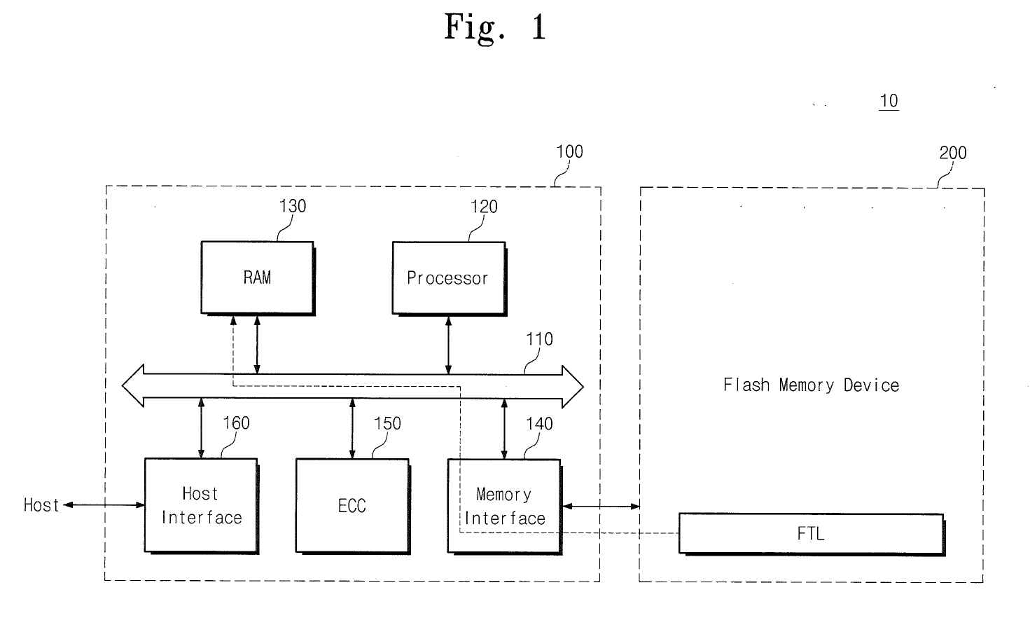

FIG. 1 is a block diagram of a memory system 10 according to an embodiment of the inventive concept.

Referring to FIG. 1, the memory system 10 includes a controller 100 and a flash memory device 200.

The controller 100 is connected to a host and the flash memory device 200. The controller 100 is configured to access the flash memory device 200 in response to a request from the host. For example, the controller 100 is configured to control a read/program/erase operation of the flash memory device 200. The controller 100 is configured to provide an interface between the flash memory device 200 and the host. The controller 100 is configured to drive a firmware for controlling the flash memory device 200.

The controller 100 includes an internal bus 110, a processor 120, a random access memory (RAM) 130, a memory interface 140, an error correction block 150, and a host interface 160.

The internal bus 110 provides a channel between the components of the controller 100. For example, the internal bus 110 may be a common channel for transmission of data and commands. As another example, the internal bus 110 may include a command channel for transmission of commands and a data channel for transmission of data.

The processor 120 is configured to control an overall operation of the controller 100. The processor 120 is configured to execute firmware and software driven in the controller 100.

The RAM 130 may be used as a working memory of the processor 120. The RAM 130 may be used as a buffer memory between the flash memory device 200 and the host. The RAM 130 may be used as a cache memory between the flash memory device 200 and the host. For example, the RAM 130 may include at least one of various random-access memories such as SRAMs, DRAMs, SDRAMs, PRAMs, MRAMs, RRAMs, FRAMs and NOR flash memories.

The memory interface 140 may include a protocol for communication with the flash memory device 200. For example, the memory interface 140 may include at least one of flash interfaces such as a NAND interface and a NOR interface.

The error correction block 150 may be configured to detect/correct an error in data read from the flash memory device 200.

The host interface 160 may include a protocol for data exchange between the host and the controller 100. For example, the controller 100 may be configured to communicate with external devices through at least one of various interface protocols such as USB (Universal Serial Bus), MMC (Multimedia Card), PCI (Peripheral Component Interconnection), PCI-E (PCI-Express), ATA (Advanced Technology Attachment), Serial-ATA, Parallel-ATA, SCSI (Small Computer Small Interface), ESDI (Enhanced Small Disk Interface) and IDE (Integrated Drive Electronics).

The controller 100 and the flash memory device 200 may be integrated into one semiconductor device. As an example, the controller 100 and the flash memory device 200 may be integrated into one semiconductor device to constitute a memory card. For example, the controller 100 and the flash memory device 200 may be integrated into one semiconductor device to constitute a PC card (e.g., PCMCIA (Personal Computer Memory Card International Association)), a compact flash card (CF), a smart media card (SM/SMC), a memory stick, a multimedia card (e.g., MMC, RS-MMC and MMCmicro), a SD card (e.g., SD, miniSD, microSD and SDHC), or a universal flash storage (UFS).

The controller 100 and the flash memory device 200 may be integrated into one semiconductor device to constitute a solid state drive (SSD). For example, the SSD may include a storage device that is configured to store data in a semiconductor memory. When the memory system 10 is used as an SSD, the operation speed of the host connected to the memory system 10 may increase remarkably.

The memory system 10 may be applicable to computers, portable computers, UMPCs (Ultra Mobile PCs), workstations, net-books, PDAs, web tablets, wireless phones, mobile phones, smart phones, digital cameras, digital audio recorders, digital audio players, digital picture recorders, digital picture players, digital video recorders, digital video players, devices capable of transmitting/receiving information in wireless environments, one of various electronic devices constituting a home network, one of various electronic devices constituting a computer network, one of various electronic devices constituting a telematics network, or one of various components constituting a computing system (e.g., an SSD and a memory card).

The flash memory device 200 or the memory system 10 may be mounted in various types of packages. Examples of the packages of the flash memory device 200 or the memory system 10 include Package on Package (PoP), Ball Grid Arrays (BGA), Chip Scale Packages (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP).

The flash memory device 200 stores a flash translation layer (FTL). The FTL provides various means for controlling the flash memory device 200.

The flash memory device 200 has different characteristics than typical memory devices. Specifically, the flash memory device 200 has erase-before-write characteristics. The read/program operation unit and the erase operation unit of the flash memory device 200 are different from each other. A read/program operation of the flash memory device 200 is performed by the page, while an erase operation of the flash memory device 200 is performed by the memory block. A memory block includes a plurality of pages. Also, the flash memory device 200 is limited in terms of the program/erase frequency. The erase time, the program time and the read time of the flash memory device 200 are different from each other.

When the host accesses the flash memory device 200, the FTL provides various control means based on the above characteristics of the flash memory device 200.

For example, the FTL provides a means for translating a logical address LA, received from the host, into a physical address PA of the flash memory device 200. The FTL retains information about the mapping relationship between the logical address LA and the physical address PA in a table.

The FTL provides a means for equalizing the program/erase frequencies of the memory blocks of the flash memory device 200. For example, the FTL provides a wear leveling means.

The FTL provides a means for minimizing the erase frequency of the flash memory device 200. For example, the flash memory device 200 provides a control means such as merge/garbage collection.

In a power-on mode, the memory system 10 performs a power-on read operation. At this point, the controller 100 reads the FTL from the flash memory device 200. The read FTL is stored in the RAM 130. The processor 120 drives the FTL stored in the RAM 130.

For example, the RAM 130 may be a nonvolatile RAM such as a PRAM, an MRAM, an RRAM, an FRAM and a NOR flash memory. In this case, the FTL may be retained in the RAM 130 without being separately stored in the flash memory device 200.

For example, the FTL may be stored in the RAM 130 and a separate nonvolatile RAM (not illustrated). In this case, the processor 120 may drive the FTL stored in the separate nonvolatile RAM, and the FTL may not be separately stored in the flash memory device 200.

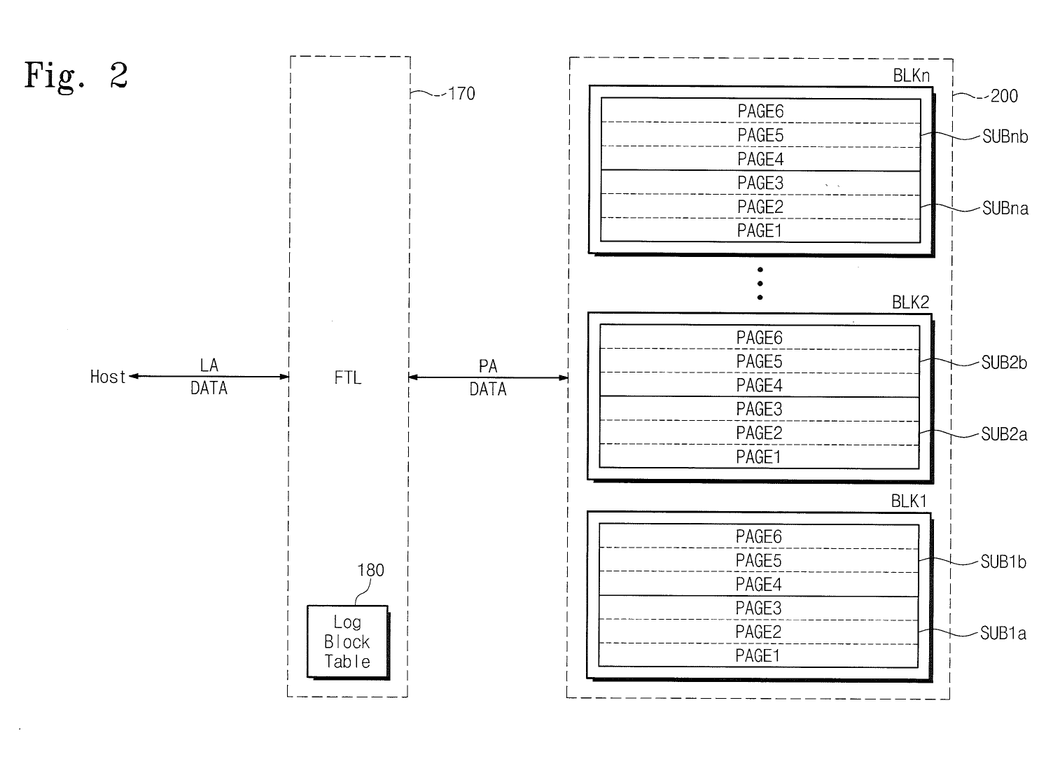

FIG. 2 is a block diagram illustrating a method for the FTL of FIG. 1 to control the flash memory device 200.

Referring to FIG. 2, a reference numeral 170 denotes the FTL. Specifically, a reference numeral 170 denotes the FTL driven by the processor 120 of FIG. 1.

The flash memory device 200 includes a plurality of memory blocks BLK1˜BLKn. Each of the memory blocks BLK1˜BLKn is the unit of an erase operation. Each of the memory blocks BLK1˜BLKn includes a plurality of pages PAGE1˜PAGE6. Each of the pages PAGE1˜PAGE6 is the unit of a read/program operation. For example, it is illustrated in FIG. 2 that each of the memory blocks BLK1˜BLKn includes first to sixth pages PAGE1˜PAGE6. However, the number of the pages of each memory block is not limited.

The FTL 170 receives a logical address LA and program data DATA corresponding to the logical address LA from the host. The FTL 170 translates the logical address LA into a physical address PA of the flash memory device 200. The FTL 170 transmits the physical address PA and the program data DATA to the flash memory device 200. The flash memory device 200 programs the program data DATA in a storage region corresponding to the physical address PA.

The FTL 170 divides each memory block into a plurality of storage regions for management. For example, it is illustrated in FIG. 2 that each of the memory blocks BLK1˜BLKn is divided into two subblocks SUB1a and SUB1b/SUB2a and SUB2b/SUBna and SUBnb. However, the number of the storage regions of the memory block is not limited.

The FTL 170 manages the subblocks of each memory block independently. For example, the FTL 170 sets the subblocks to a free block, a data block and a log block independently.

For example, the free block represents a block that is not programmed with data and is not set to perform a specific function. That is, the free block represents a block that is not used. The data block represents a block that is programmed with data. The log block represents a block that is programmed with update data of the data of the data block. That is, the data block represents a block that is set to program data, the log block represents a block that is set to update data, and the free block represents a block that is not used.

Hereinafter, the terms “free subblock”, “free log block”, “free data block” and “free random sequence block” are used. The free subblock represents a subblock that is a free block. The free log block represents an empty log block (or a log subblock) that is not programmed with data. The free data block represents an empty data block (or a data subblock) that is not programmed with data. The free random sequence block represents an empty random sequence block that is not programmed with data.

The FTL 170 maps the logical address LA and the physical address PA on the basis of a block mapping table (not illustrated). The block mapping table is formed by the subblock. The block mapping table may be defined as Table 1.

TABLE 1

Physical Address (PA)

| Logical Address (LA) | Block Number | Subblock Offset |
|---|---|---|
| Logical Block 1 | 1 | a |
| Logical Block 2 | 1 | b |
| Logical Block 3 | 2 | a |
| Logical Block 4 | 2 | b |
| Logical Block 5 | n | a |
| Logical Block 6 | n | b |

For example, one logical block represents the group of logical addresses corresponding to the storage capacity of one subblock. The addresses of one logical block are sequential. For example, if the storage capacity of one subblock corresponds to 3 sectors, each logical block includes addresses corresponding to 6 sectors. If the flash memory device 200 includes 6 subblocks, 18 sequential sector addresses (logical addresses) are allocated to the flash memory device 200. The first to third sector addresses correspond to the first logical block, and the fourth to sixth sector addresses correspond to the second logical block. Likewise, the 16^{th} to 18^{th} sector addresses correspond to the sixth logical block.

The FTL 170 programs program data DATA so that a page offset (or sequence) of a subblock corresponding to an address offset (or sequence) of each logical block is identical. For example, data corresponding to the first sector address (logical address) of the first logical block are programmed in the first page of the corresponding subblock. Data corresponding to the second sector address of the first logical block are programmed in the second page of the corresponding subblock. Likewise, data corresponding to the j^{th} sector address of the i^{th} logical block are programmed in the j^{th} page of the corresponding subblock.

For example, the first logical block includes data corresponding to the first to third addresses. Herein, the data corresponding to the first to third addresses are sequentially programmed in the first to third pages PAGE1˜PAGE3 of the first subblock BLK1a of the first memory block BLK1. The second logical block includes data corresponding to the fourth to sixth addresses. Herein, the data corresponding to the fourth to sixth addresses are sequentially programmed in the fourth to sixth pages PAGE4˜PAGE6 of the second subblock BLK1b of the first memory block BLK1.

The FTL 170 performs a program/read operation with reference to the block mapping table. With reference to the block mapping table, the FTL 170 detects a block number and a subblock offset corresponding to a received address. The detected offset is used as a page offset of a subblock. That is, when an address is received, the FTL 170 may detect a block number, a subblock offset, and a page offset. For example, it is assumed that a program/read request for the third address is received from the host. Herein, the FTL 170 outputs a physical address PA corresponding to the third page PAGE3 of the first subblock BLK1a of the first memory block BLK1.

The FTL 170 includes a log block table 180. The log block table 180 stores information about log blocks. For example, the log block table 180 stores information about the allocation relationship between the log blocks and the data blocks.

The number of log blocks retainable by the FTL 170 is limited. For example, the FTL 170 acquires a free log block when a log block is necessary. For example, the FTL 170 sets one of free subblocks to a log block. For example, the FTL 170 retains a predetermined number of log blocks. That is, when one log block is invalid, the FTL 170 sets one of free subblocks to a free log block.

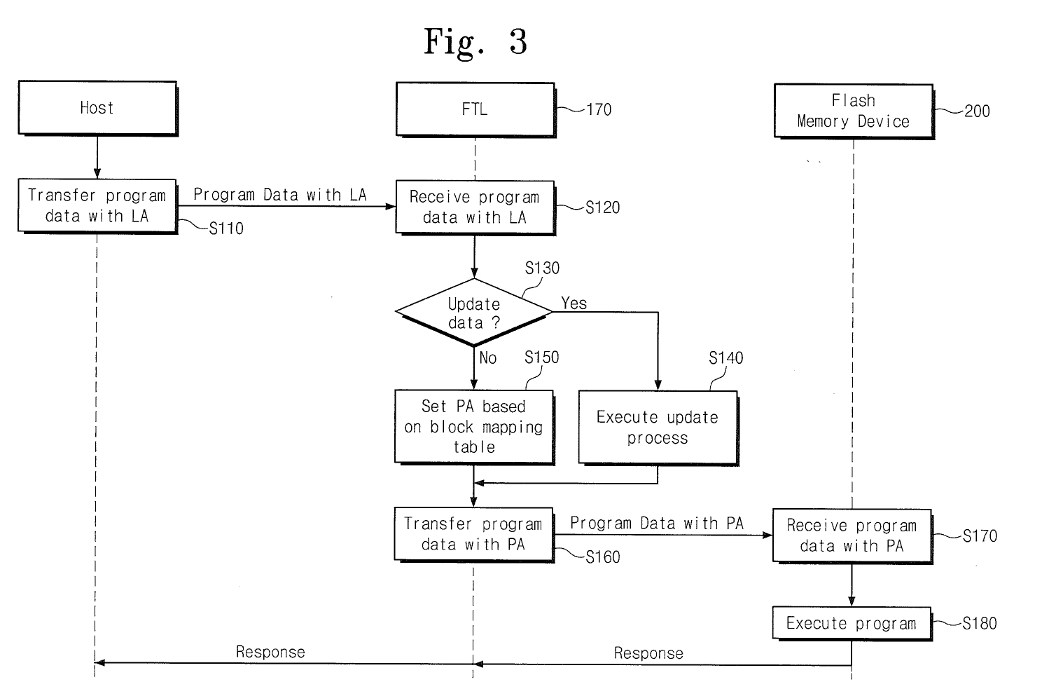

FIG. 3 is a flow chart illustrating the operations of the host, the FTL 170 and the flash memory device 200.

Referring to FIGS. 1 to 3, in step S110, the host transfers program data DATA and a logical address LA to the FTL 170. In step S120, the FTL 170 receives the program data DATA and the logical address LA from the host.

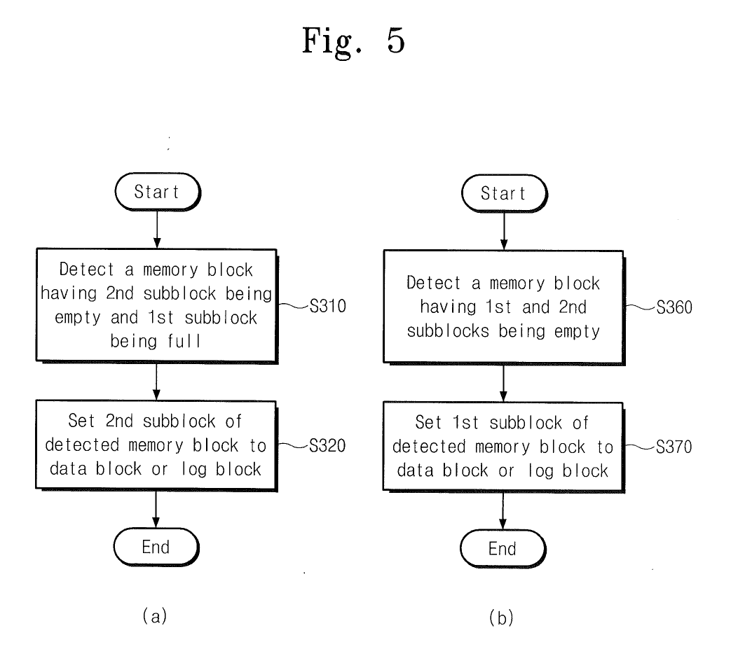

In step S130, the FTL 170 determines whether the program data DATA are update data. If the program data DATA are update data, an update process is performed in step S140. For example, in step S140, the FTL 170 sets a physical address PA corresponding to the update data. The update process in step S140 will be described later in detail with reference to FIG. 5. If the program data DATA are not update data, the FTL 170 proceeds to step S150.

In step S150, the FTL 170 sets a physical address PA with reference to the block mapping table. For example, the FTL 170 sets a block number, a subblock offset and a page offset with reference to the block mapping table.

For example, if a data block corresponding to a logical address LA is not set, the FTL 170 sets a selected free subblock to a data block. Also, the FTL sets a physical address PA to an address of a predetermined data block. The FTL 170 updates the block mapping table. For example, the FTL 170 stores information, which indicates that a data block corresponding to the logical address LA is set, in the block mapping table.

In step S160, the FTL 170 transfers program data DATA and a predetermined physical address PA to the flash memory device 200.

In step S170, the flash memory device 200 receives the program data DATA and the physical address PA from the FTL 170. In step S180, the flash memory device 200 programs the program data DATA with reference to the physical address PA. Thereafter, a response signal indicating completion of the program is transferred.

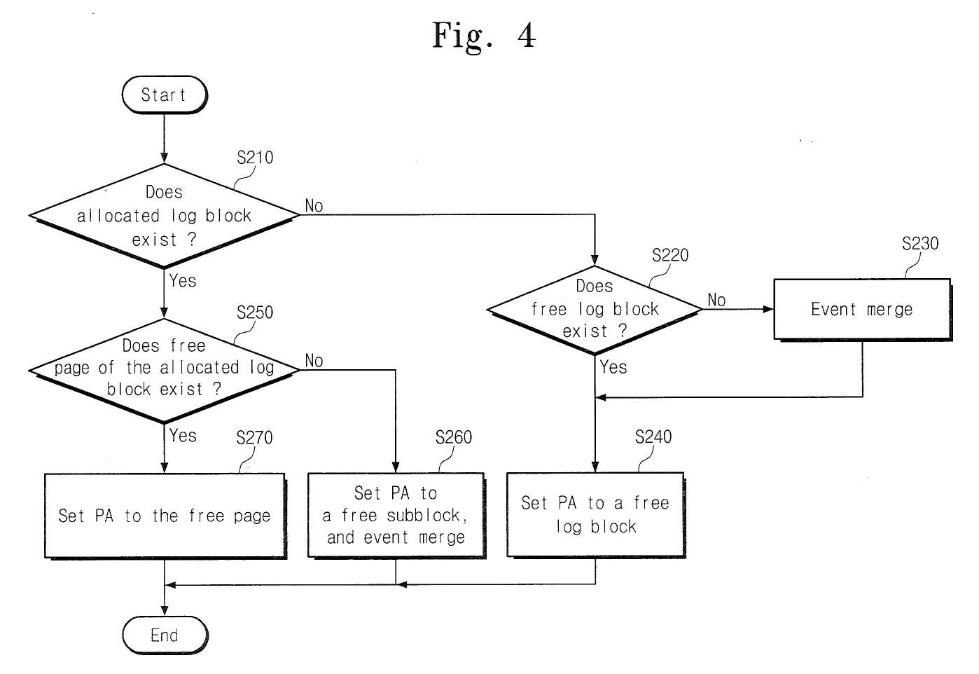

FIG. 4 is a flow chart illustrating the update process (step S140) of FIG. 3.

Referring to FIGS. 2 to 4, in step S210, the FTL 170 determines whether an allocated log block is present. For example, the FTL 170 determines whether a log block allocated to a data block corresponding to update data is present. If the log block is not present, step S220 is performed.

In step S220, the FTL 170 determines whether a free log block is present. If the free log block is present, the FTL 170 sets the physical address PA to an address of the free log block, in step S240.

For example, if the FTL 170 retains a predetermined number of log blocks, if the free log block is not present, the FTL 170 performs a merge operation in step S230. When the merge operation of step S230 is performed, a free log block is acquired. For example, by the merge operation, one of the previous log blocks is set to an invalid block and one of the free subblocks is set to a free log block. Thereafter, in step S240, the FTL 170 sets the physical address PA to an address of the free log block. Herein, information about the log block set to an invalid block, information about the acquired free log block, and information about the allocation of the acquired free log block to the data block are stored in the log block table 180.

For example, if the FTL 170 does not retain a predetermined number of log blocks, the FTL 170 determines whether the number of log blocks reaches a limit value. If the number of log blocks reaches the limit value, a merge operation is performed as described above. If the number of log blocks does not reach the limit value, the FTL 170 sets one of the free subblocks to a log block.

If the allocated log block is present (in step S210), step S250 is performed. In step S250, the FTL 170 determines whether a free page is present in the allocated log block. If a free page is not present in the allocated log block, the FTL 170 sets the physical address PA to an address of the free subblock and performs a merge operation, in step S260. When the merge operation of step S260 is performed, data of the data block corresponding to update data, the latest data among the data of the allocated log block, and a new data block storing the update data are set.

That is, the latest data among the data of the data block corresponding to the update data are copied into the selected free subblock. The latest data among the data of the allocated log block are copied into the selected free subblock. Also, the update data are programmed in the selected free subblock. The selected free subblock is set to a data block. The FTL 170 sets the previous data block and log block to invalid blocks.

At this point, the block mapping table and the log block table 180 are updated. For example, information, which indicates that the data block is changed by the merge operation, is stored in the block mapping table. Also, information, which indicates that the previous data block is set to an invalid block, is stored in the block mapping table. Information, which indicates that the allocated log block is removed by the merge operation, is stored in the log block table 180.

For example, if the FTL 170 retains a predetermined number of log blocks, the FTL 170 sets one of the free subblocks to a new free log block. Information, which indicates that the new free log block is set, is stored in the log block table 180.

If a free page is present in the allocated log block (in step S250), step S270 is performed. In step S270, the FTL 170 sets the physical address PA to an address of the free page of the allocated log block.

It has been described in step S150 of FIG. 3 that the FTL 170 may set a free subblock to a data block. It has been described in step S230 of FIG. 4 that the FTL 170 may set a free subblock to a log block. Also, it has been described in step S260 of FIG. 4 that the FTL 170 may set a free subblock to a data block.

FIGS. 5A and 5B are flow charts illustrating a method for setting a free block to a data block or a log block in FIGS. 3 and 4.

Referring to FIG. 5A, in step S310, the FTL 170 detects a memory block corresponding to a first condition. A first subblock of the memory block corresponding to the first condition is one of a full data block, a full log block and an invalid block, and a second subblock thereof is a free subblock.

In step S320, the FTL 170 sets the second subblock of the detected memory block to a data block or a log block.

The program sequence of the pages PAGE1˜PAGE6 of the flash memory device 200 of FIG. 2 is predetermined. For example, the pages PAGE1˜PAGE6 of one memory block are programmed in a predetermined sequence in order to prevent the disturbance caused by the coupling effect. Generally, in one memory block, program operations are sequentially performed in the order from the page corresponding to the first word line to the page corresponding to the n^{th} word line.

For example, it is assumed that each of the memory blocks BLK1˜BLKn of the flash memory device 200 is programmed in the order from the first page PAGE1 to the sixth page PAGE6. Herein, the first subblock SUB1a/SUB2a/SUBna of each of the memory blocks BLK1˜BLKn is set to include a first page PAGE1 and the second subblock SUB1b/SUB2b/SUBnb is set to include a sixth page PAGE6.

In one memory block (e.g., BLK1), the second subblock SUB1b may be programmed after the first subblock SUB1a is programmed. However, the first subblock SUB1a may not be programmed after the second subblock SUB1b is programmed. This is because it is contradictory to the program sequence of the pages PAGE1˜PAGE6 of the memory block BLK1. That is, in the memory block BLK1, the first subblock SUB1a is program-inhibited when the second subblock SUB1b is programmed.

When the first subblock SUB1a of the memory block BLK1 includes a free capacity (i.e., when the first subblock SUB1a is not full), if the second subblock SUB1b is programmed, the free capacity of the first subblock SUB1a is set to a region incapable of being programmed with data. That is, there occurs a discarded capacity among the storage capacity of the memory block BLK1.

According to the block setting method described with reference to FIG. 5A, when the first subblock SUB1a is full, the second subblock SUB1b is set to a data block or a log block. Thus, the storage capacity of the memory block BLK1 is prevented from being discarded.

Referring to FIG. 5B, in step S360, the FTL 170 detects a memory block corresponding to a second condition. First and second subblocks of the memory block corresponding to the second condition are free subblocks.

In step S370, the FTL 170 sets the first subblock SUB1a of the detected memory block to a data block or a log block. According to the block setting method described with reference to FIG. 5B, the storage capacity of the memory block BLK1 is prevented from being discarded.

The block setting method of FIG. 5A and the block setting method of FIG. 5B may be used in combination.

For example, when one of the free subblocks is set to a data block or a log block, the FTL 170 detects a memory block corresponding to the first condition described with reference to FIG. 5A. If the memory block corresponding to the first condition is detected, the FTL 170 sets the second free subblock of the detected memory block to a data block or a log block. If the memory block corresponding to the first condition is not detected, the FTL 170 detects a memory block corresponding to the second condition described with reference to FIG. 5B. If the memory block corresponding to the second condition is detected, the FTL 170 sets the first free subblock of the detected memory block to a data block or a log block.

If the memory block corresponding to the second condition is not detected, the FTL 170 sets a random free subblock to a data block or a log block. The random free subblock corresponds to the second free subblock of a memory block corresponding to a third condition. The first subblock of the memory block corresponding to the third condition is a data block or a log block including a free capacity.

The execution sequence of the block setting method of FIG. 5A and the block setting method of FIG. 5B may vary. For example, the FTL 170 may detect a free subblock corresponding to the second condition, detect a free subblock corresponding to the first condition, and then detect a free subblock corresponding to the third condition.

That is, the FTL 170 may preferentially set a free subblock corresponding to the first or second condition to a data block or a log block. When there is no free subblock corresponding to the first or second condition, the FTL 170 sets a free subblock corresponding to the third condition to a data block or a log block. Thus, the discard of a free capacity can be minimized.

The FTL 170 may pad a discarded free capacity. That is, the FTL 170 may be set to program data in the discarded free capacity. In this case, the free capacity of the flash memory device 200 is equal to the actual program capacity. Thus, a mismatch, which may occur when the FTL 170 or the host manages the free capacity of the flash memory device 200, can be prevented.

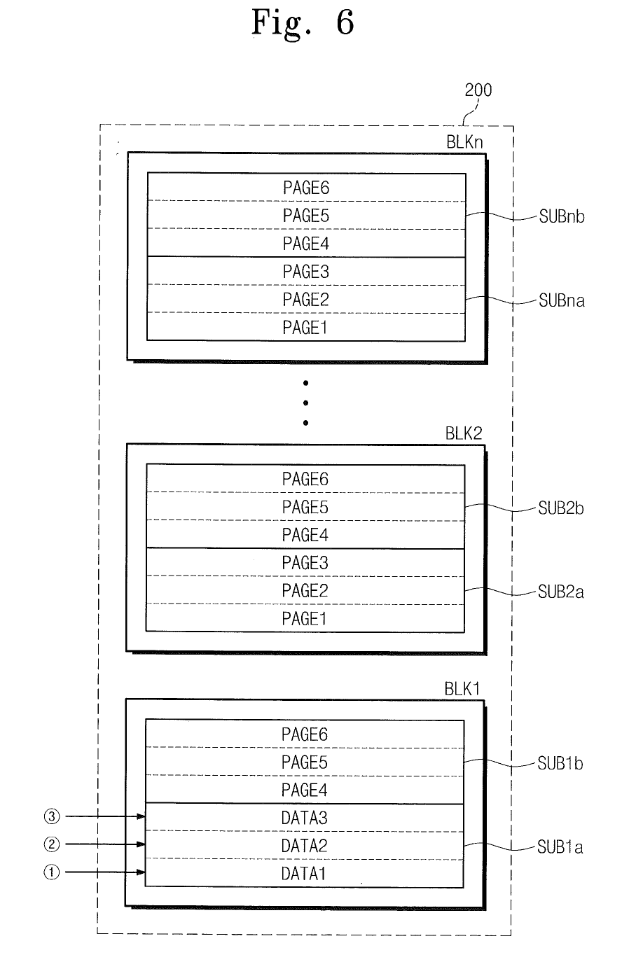

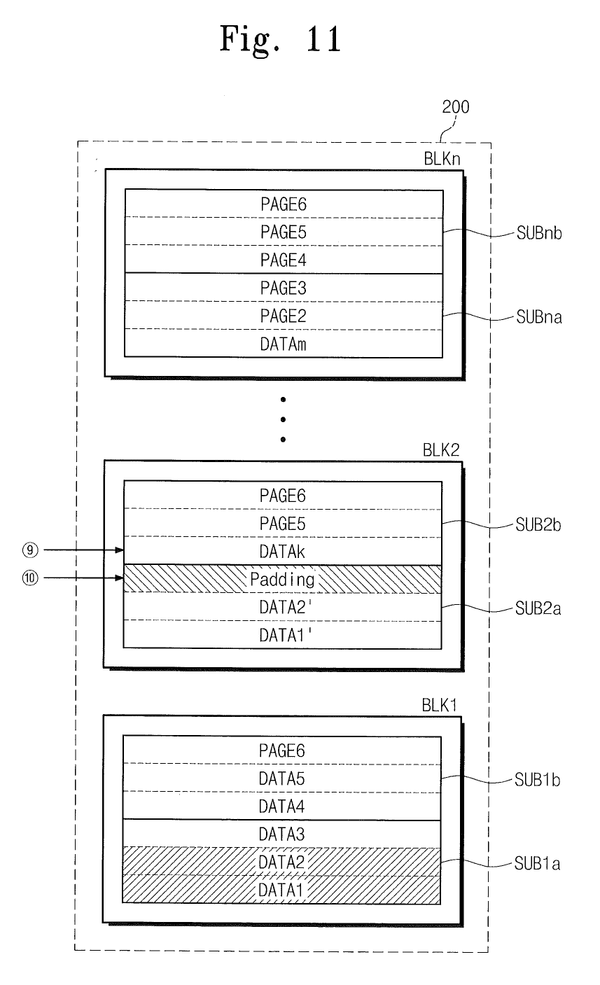

FIGS. 6 to 11 are block diagrams illustrating a method for the FTL 170 to perform a block setting operation according to the block setting method described with reference to FIGS. 3 to 5.

For simplicity's sake, the illustration of the FTL 170 is omitted in FIGS. 6 to 11.

Hereinafter, a block setting method according to an embodiment of the present invention will be described with reference to FIGS. 3 to 6. For example, it is assumed that a program request for the first to third data DATA1˜DATA3 is received from the host. It is assumed that the logical addresses corresponding to the first to third data DATA1˜DATA3 correspond to the same logical block. Also, it is assumed that the first to third data DATA1˜DATA3 are not update data.

As described with reference to step S150 of FIG. 3, the FTL 170 sets the physical address PA corresponding to the first to third data DATA1˜DATA3 with reference to the block mapping table.

As described with reference to FIGS. 5A and 5B, the FTL 170 sets a data block according to the first to third conditions. For example, it is assumed that the FTL 170 sets the first free subblock SUB1a of the first memory block BLK1 to a data block. In this case, as illustrated in FIG. 6, the first to third data DATA1˜DATA3 are sequentially programmed in the first to third pages PAGE1˜PAGE3 of the set data block SUB1a.

Hereinafter, a block setting method according to another embodiment of the present invention will be described with reference to FIGS. 3 to 5 and 7. For example, it is assumed that a program request for the first data DATA1 is received from the host. As described with reference to step S130 of FIG. 3, the FTL 170 performs an update process of step S140.

As described with reference to step S210 of FIG. 4, the FTL 170 determines whether an allocated log block is present. An allocated log block is not present in the data block SUB1a. As described with reference to step S220 of FIG. 4, the FTL 170 determines whether a free log block is present. For example, it is assumed that the first subblock SUB2a of the second memory block BLK2 is a free log block. As described with reference to step S240 of FIG. 4, the FTL 170 allocates a free log block SUB2a to a data block SUB1a. Also, the updated first data DATA1′ are programmed in the log block SUB2a.

The FTL 170 updates the log block table 180. For example, the FTL 170 stores information, which indicates that the log block SUB2 is allocated to the data block SUB1a, in the log block table 180.

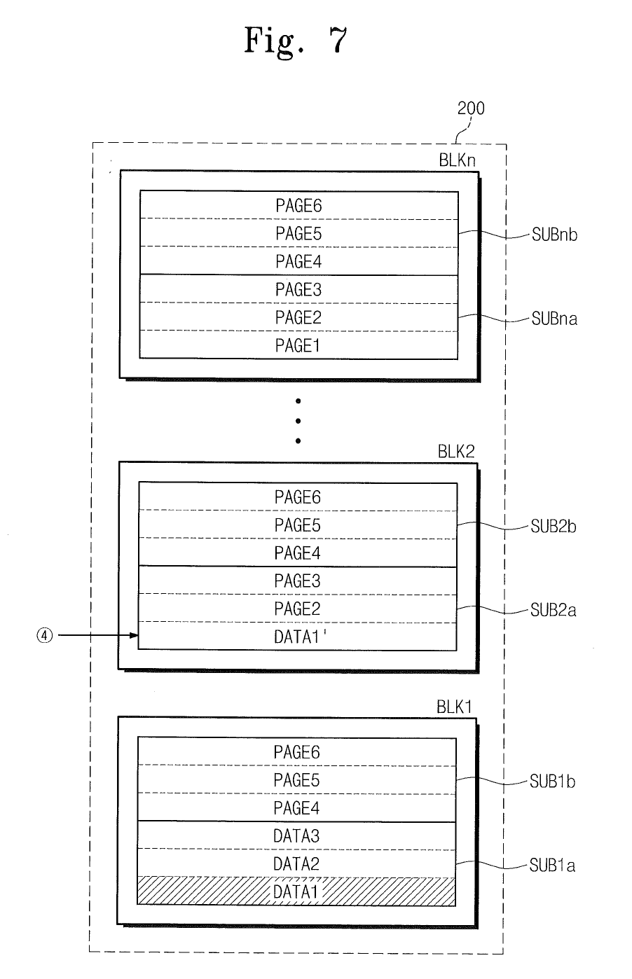

In FIG. 7, the first data DATA1 is represented by oblique lines. For example, the FTL 170 may additionally perform an operation of setting the previous first data DATA1 to invalid data. For example, information, which indicates that the first data DATA1 are set to invalid data, is stored in the log block table 180.

Hereinafter, a block setting method according to another embodiment of the present invention will be described with reference to FIGS. 3 to 5 and 8. For example, it is assumed that a program request for the fourth data DATA4 is received from the host. Also, it is assumed that the logical block corresponding to the fourth data DATA4 is different from the logical block corresponding to the first to third data DATA1˜DATA3.

As described with reference to step S150 of FIG. 3, the FTL 170 sets the physical address PA corresponding to the fourth data DATA4 with reference to the block mapping table.

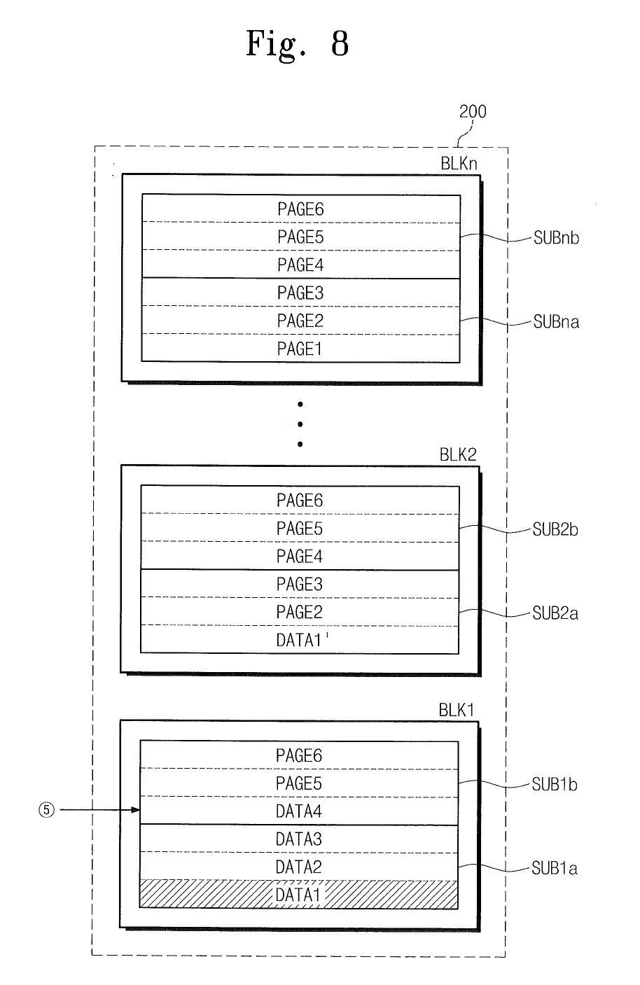

As described with reference to FIGS. 5A and 5B, the FTL 170 sets a data block on the basis of the first to third conditions. For example, it is assumed that the FTL 170 sets the second free subblock SUB1b of the first memory block BLK1 to a data block. In this case, as illustrated in FIG. 8, the fourth data DATA4 are programmed in the set data block SUB1b.

Hereinafter, a block setting method according to another embodiment of the present invention will be described with reference to FIGS. 3 to 5 and 9. For example, it is assumed that a program request for the fifth data DATA5 is received from the host. Also, it is assumed that the logical block corresponding to the fifth data DATA5 is identical to the logical block corresponding to the fourth data DATA4.

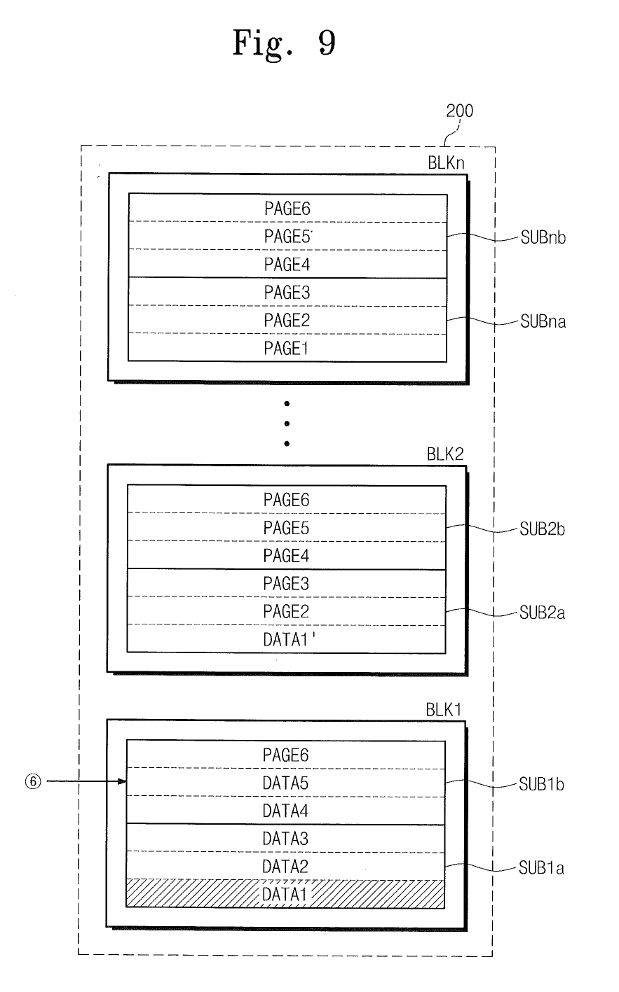

As described with reference to step S150 of FIG. 3, the FTL 170 sets the physical address PA with reference to the block mapping table. For example, as illustrated in FIG. 9, the fifth data DATA5 are programmed in the data block SUB1b.

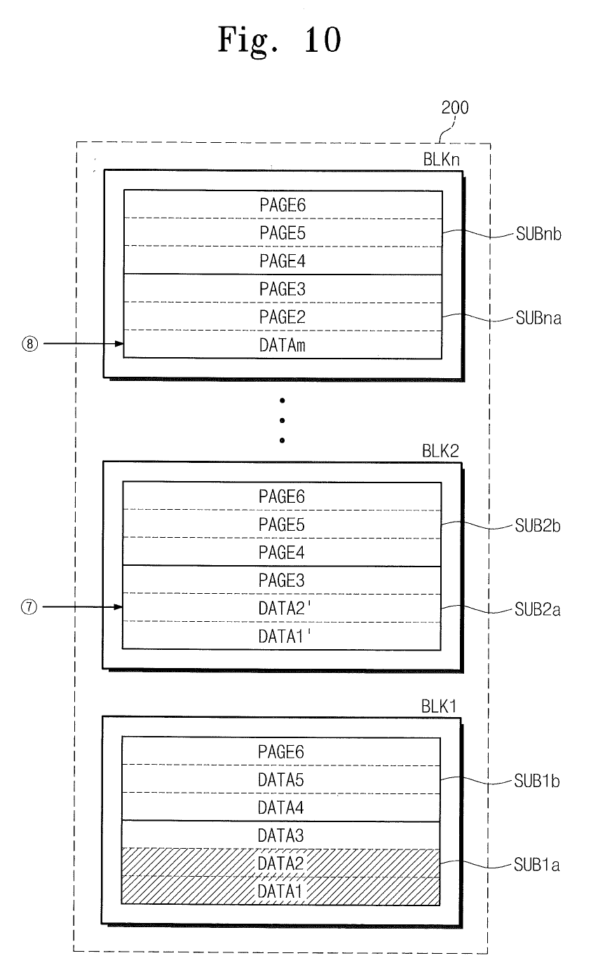

Hereinafter, a block setting method according to another embodiment of the present invention will be described with reference to FIGS. 3 to 5 and 10. For example, it is assumed that a program request for the second data DATA2 is received from the host. As described with reference to step S210 of FIG. 4, the FTL 170 determines whether an allocated log block is present. An allocated log block SUB2a is present in the data block SUB1a corresponding to the second data DATA2. As described with reference to step S220 of FIG. 4, the FTL 170 determines whether a free page is present in the log block SUB2a. A free page is present in the log block SUB2a. Thus, as illustrated in FIG. 10, update data DATA2′ are programmed in the log block SUB2a. The FTL 170 may additionally perform an operation of setting the previous second data DATA2 to invalid data.

Thereafter, it is assumed that the m^{th} data DATAm are programmed in the first free subblock SUBna of the n^{th} memory block BLKn at the request of the host. That is, it is assumed that the logical block corresponding to the m^{th} data DATAm is different from the logical blocks corresponding to the first to fifth data DATA1˜DATA5.

Hereinafter, a block setting method according to another embodiment of the present invention will be described with reference to FIGS. 3 to 5 and 11. For example, it is assumed that a program request for the k^{th} data DATAk is received from the host. Also, it is assumed that the logical block corresponding to the k^{th} data DATAk is different from the logical blocks corresponding to the first to fifth data DATA1˜DATA5 and the m^{th} data DATAm.

As described with reference to step S150 of FIG. 3, the FTL 170 sets the physical address PA on the basis of the block mapping table. As described with reference to FIGS. 5A and 5B, the FTL 170 sets a data block according to the first to third conditions.

The memory block corresponding to the first and second conditions, among the memory blocks BLK1˜BLKn, is not present. Thus, the FTL 170 sets a data block according to the third condition. The memory blocks corresponding to the third condition are the second and n^{th} memory blocks BLK2 and BLKn. For example, it is assumed that the FTL 170 sets the second free subblock SUB2b of the second memory block to a data block. That is, the k^{th} data DATAk are programmed in the data block SUB2b.

Thereafter, the log block SUB2a is program-inhibited. The FTL 170 may additionally perform an operation of padding a free capacity of the log block SUB2a.

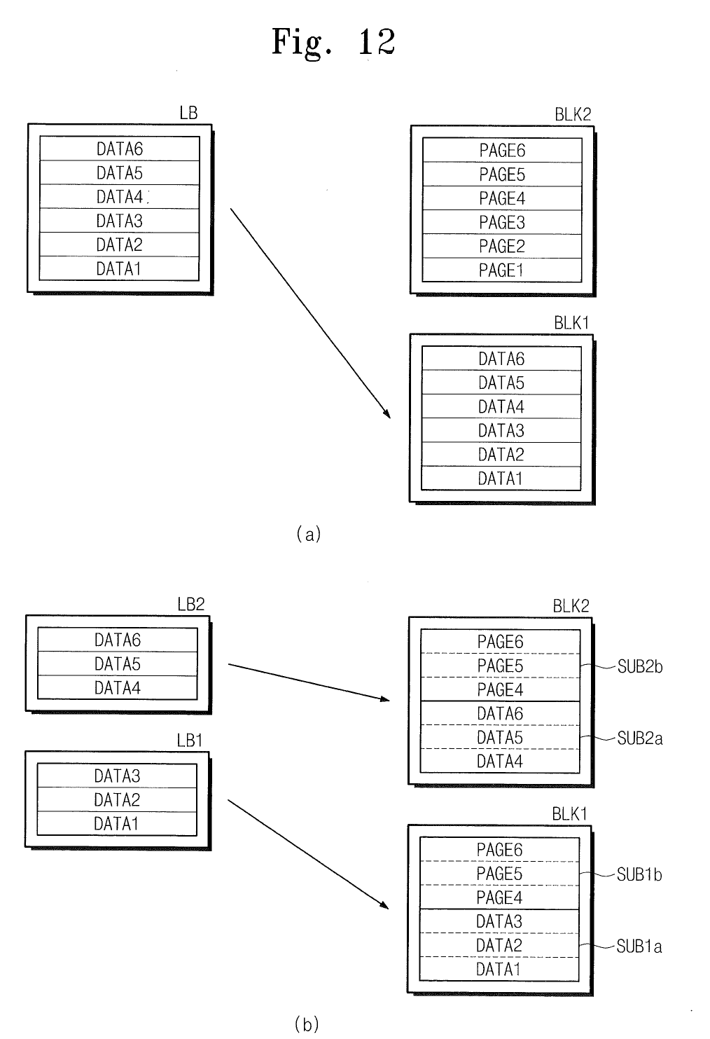

FIGS. 12A and 12B are block diagrams illustrating an embodiment of setting a data block according to the second condition.

Referring to FIG. 12A, each of the memory blocks is set to one of a free block, a data block and a log block independently. The first to sixth data DATA1˜DATA6 corresponding to one logical block LB are programmed in one memory block (e.g., BLK1).

Referring to FIG. 12B, each of the subblocks of the memory blocks is set to one of a free block, a data block and a log block independently. Data corresponding to one logical block LB of FIG. 12A correspond to two logical blocks LB1 and LB2 in FIG. 12B. If a data block is set according to the second condition, the first free subblock SUB1a of the first memory block BLK1 and the first free subblock SUB2a of the second memory block BLK2 are set to data blocks. That is, data corresponding to the first and second logical blocks LB1 and LB2 are stored in the first and second memory blocks BLK1 and BLK2 in a distributed manner.

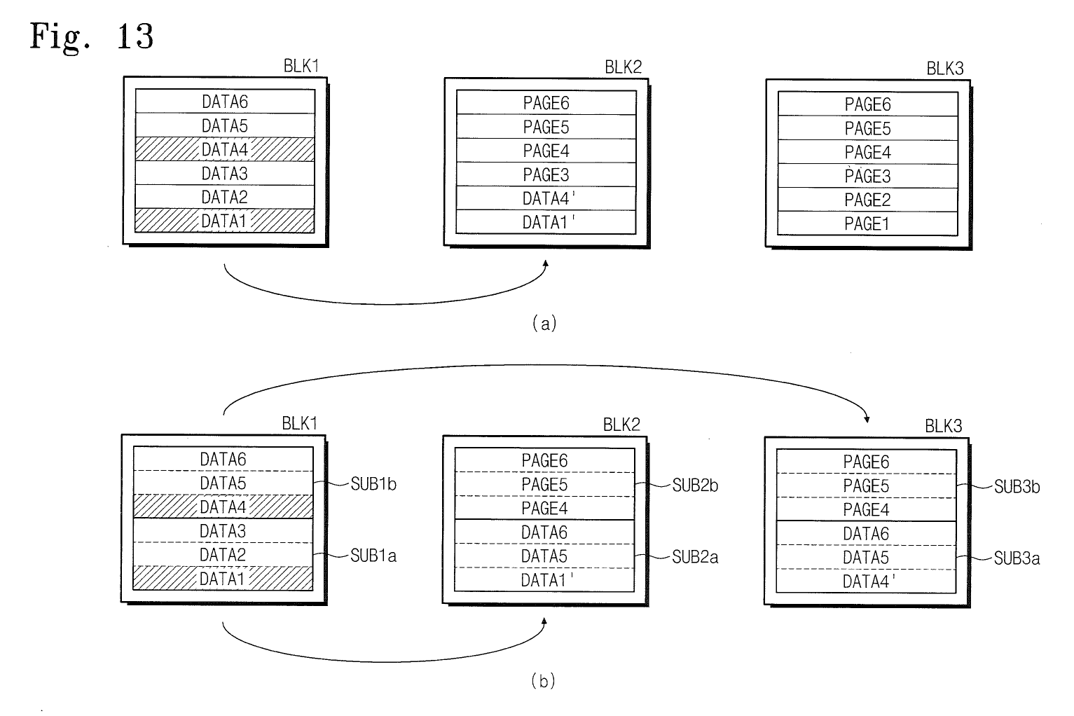

FIGS. 13A and 13B are block diagrams illustrating an embodiment of setting a data block according to the first and second conditions.

Referring to FIG. 13A, it is assumed that the first to sixth data DATA1˜DATA6 are programmed. When one memory block is set to one of a data block, a log block and a free block, the memory block BLK1 is set to one data block. The first to sixth data DATA1˜DATA6 are programmed in one memory block BLK1. When the first and fourth data DATA1 and DATA4 are updated, one memory block BLK2 is set to a log block. Also, the updated data are programmed in one log block BLK2.

Referring to FIG. 13B, it is assumed that the first to sixth data DATA1˜DATA6 are programmed. When a data block is set according to the first and second conditions, the first subblock SUB1a of the first memory block BLK1 is set to a data block. Herein, the first to third data DATA1˜DATA3 are programmed in the first subblock SUB1a of the first memory block BLK1. When a data block is set according to the first and second conditions, the second subblock SUB1b of the first memory block BLK1 is set to a data block. Thus, the fourth to sixth data DATA4˜DATA6 are programmed in the second subblock SUB1b.

Thereafter, the first and fourth data DATA1 and DATA4 are updated. When the first data DATA1 are updated, a log block is allocated. For example, update data DATA1′ of the first data DATA1 are programmed in the log block SUB2a. The fourth data DATA4 correspond to a different data block than the first data DATA1. Thus, when the fourth data DATA4 are updated, a new log block is allocated. For example, update data DATA4′ of the fourth data DATA4 are programmed in the log block SUB3a.

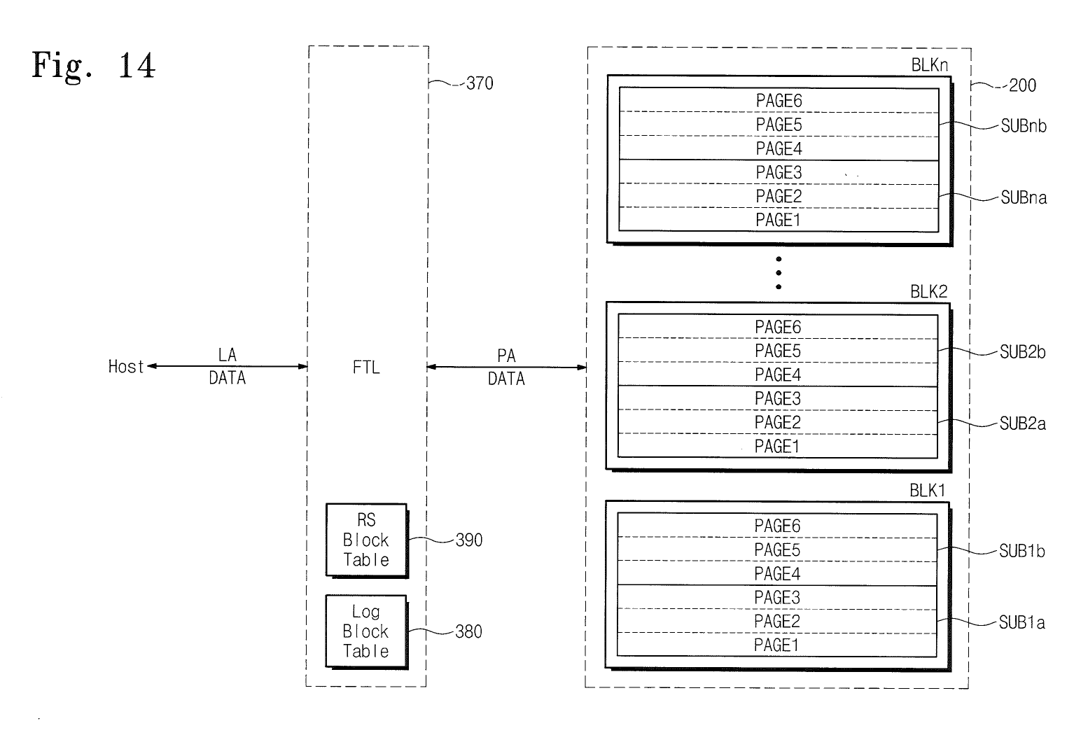

FIG. 14 is a block diagram illustrating another embodiment of the FTL 170 of FIG. 2.

In FIG. 14, the flash memory device 200 is configured in the same way as described with reference to FIGS. 2 to 13. An FTL 370 operates in the same way as described with reference to FIGS. 2 to 13, with the exception that it further includes a random sequence (RS) block table 390. The RS block table 390 is configured to store information about RS blocks.

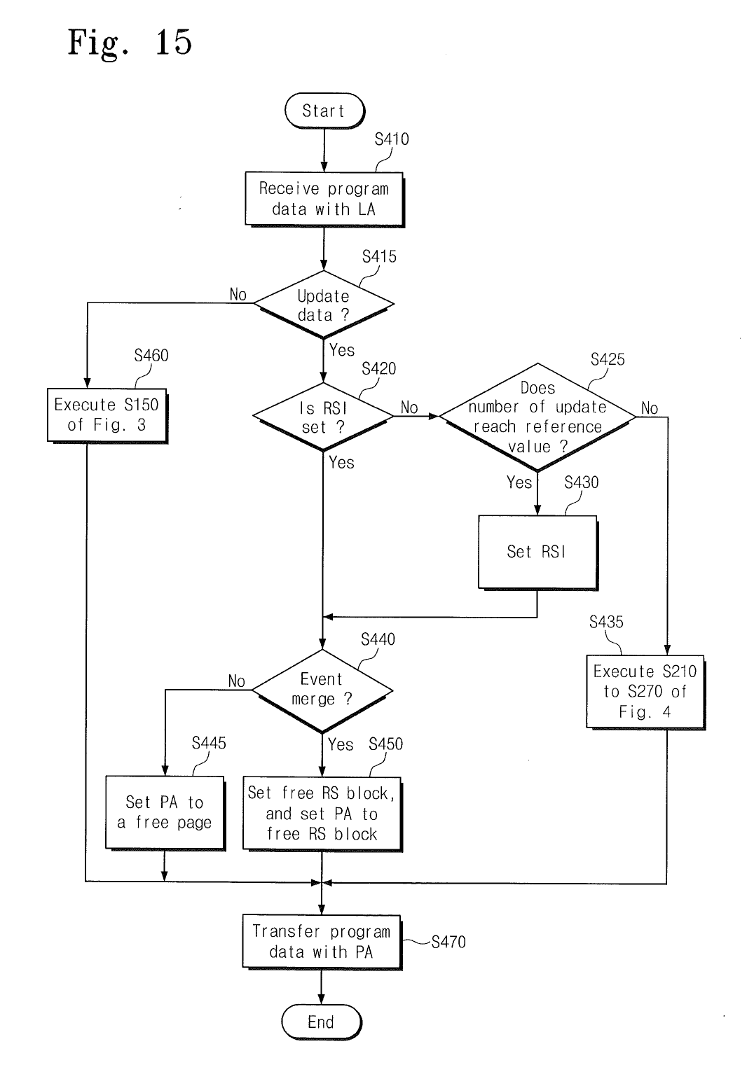

FIG. 15 is a flow chart illustrating an embodiment 1 of the operation method of the FTL 370 of FIG. 14.

Referring to FIGS. 14 and 15, program data DATA and a corresponding logical address LA are received in step S410. Step S410 is performed in the same way as step S120 of FIG. 3.

In step S415, the FTL 370 determines whether the program data DATA are update data. Step S415 is performed in the same way as step S130 of FIG. 3. If the program data DATA are not update data, step S460 is performed. In step S460, step S150 of FIG. 3 is performed. That is, the FTL 370 sets the physical address PA on the basis of the block mapping table. If the program data DATA are update data, step S420 is performed.

In step S420, the FTL 370 determines whether RS information (RSI) is set. For example, the RSI is information indicating whether a data block corresponding to update data is an RS block. For example, the RSI is stored in the block mapping table. The RS block will be described later in detail. If the RSI is set, step S440 is performed. If the RSI is not set, step S425 is performed.

In step S425, the FTL 370 determines whether an update count value reaches a reference value. For example, the FTL 370 counts the number of updates of data corresponding to one logical block. For example, the count value is stored in the block mapping table. If the count value is smaller than the reference value, step S435 is performed.

In step S435, steps S210 to 5270 of FIG. 4 are performed. That is, the FTL 370 performs an update process.

If the count value reaches the reference value (in step S425), step S430 is performed. In step S430, RSI is set. Thereafter, step S440 is performed.

In step S440, the FTL 370 determines whether a merge operation is performed. For example, the FTL 370 determines whether a merge operation is performed due to the received update data. For example, it has been described that a merge operation is performed in step S150 of FIG. 3 and steps S230 and S260 of FIG. 4. If a merge operation is not performed, step S445 is performed.

In step S445, the FTL 370 sets the physical address PA to an address of the free page. For example, a merge operation is not performed if the previous data are programmed in a data block and there is a log block that is allocated in the data block and has a free page. In this case, the physical address PA is set to an address of the free page of the log block. For example, a merge operation is not performed if the previous data are programmed in an RS block with a free page. In this case, the physical address PA is set to an address of the free page of the RS block.

If a merge operation is performed (in step S440), step S450 is performed. In step S450, the FTL 370 sets a free RS block and sets the physical address PA to an address of the free RS block. For example, the FTL 370 detects a memory block corresponding to a fourth condition with reference to the block mapping table. The memory block corresponding to the fourth condition may be a memory block having a first free subblock and a second free subblock. The FTL 370 sets the first and second free subblocks of the detected memory block to one RS block. That is, in the RS block, the discrimination between the first and second subblocks is disregarded.

The RS block is a block that is sequentially programmed regardless of whether data are update data. That is, if received data correspond to an RS block, the FTL 370 sequentially programs data in the RS block regardless of whether the received data are update data. Herein, if the received data are update data, the FTL 370 sets the previous data corresponding to the update data to invalid data.

Thereafter, step S470 is performed. In step S470, the program data and the physical address PA are transferred to the flash memory device 200.

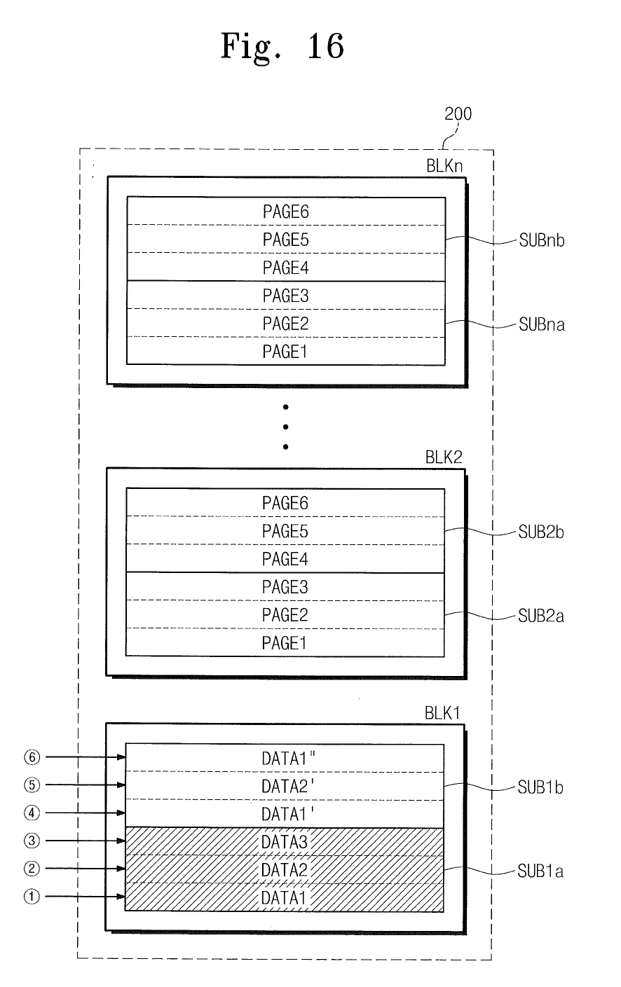

FIGS. 16 to 18 are block diagrams illustrating an embodiment of the operation method described with reference to FIG. 15.

Referring to FIGS. 15 and 16, for example, it is assumed that a program request for the first to third data DATA1˜DATA3 is received from the host. Also, it is assumed that the first to third data DATA1˜DATA3 correspond to the same logical block. The FTL 370 sets one of the free subblocks to a data block. For example, it is assumed that the FTL 370 sets the first free subblock SUB1a of the first memory block BLK1 to a data block. The first to third data DATA1˜DATA3 are programmed in the data block SUB1a.

For example, it is assumed that an update request for the first data DATA1 is received from the host. As described with reference to step S420, the FTL 370 determines whether random sequence information (RSI) is set. Because the RSI is not set, the FTL 370 determines whether an update count value reaches a reference value, as described with reference to step S425.

For example, it is assumed that the reference value is 2. Because the update count value is smaller than the reference value, step S435 is performed. That is, the FTL 370 allocates a log block to the data block SUB1a. For example, it is assumed that the FTL 370 sets the second subblock SUB1b of the first memory block BLK1 to a log block. Update data DATA1′ are programmed in the log block SUB1b. Also, the FTL 370 counts the number of updates of the logical block corresponding to the first data DATA1 as 1.

For example, it is assumed that an update request for the second data DATA2 is received from the host. Because the RSI is not set, step S420 is performed. Because the update count value is smaller than the reference value, update data DATA2′ are programmed in the log block SUB1b. The second data DATA2 correspond to the same logical block as the first data DATA1. Thus, the number of updates of the logical block corresponding to the first and second data DATA1 and DATA2 is counted as 2.

For example, it is assumed that an update request for the first data DATA1′ is received from the host. Because the update count value reaches the reference value, the FTL 370 sets RSI. Thereafter, in step S440, the FTL 370 determines whether a merge operation is performed. Because a free page is present in the log block SUB1b, a merge operation is not performed. Thus, the update data DATA1″ are programmed in the log block SUB1b.

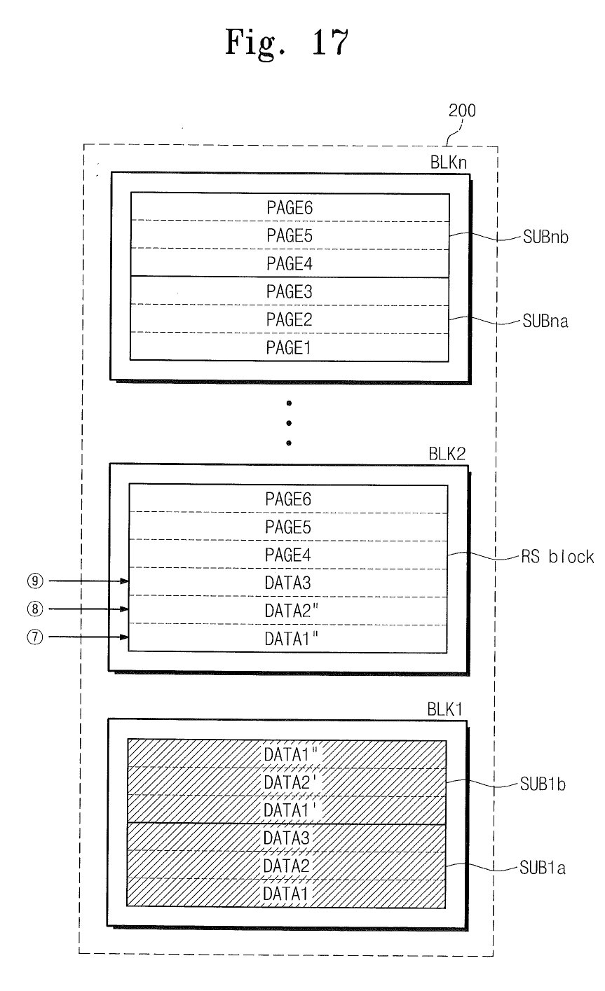

Referring to FIGS. 15 and 17, for example, it is assumed that an update request for the second data DATA2′ is received from the host. The RSI is set and the log block SUB1b is full. That is, a merge operation is performed. In step S450, the FTL 370 sets an RS block. For example, it is assumed that the FTL 370 sets the first and second subblocks SUB2a and SUB2b of the second memory block BLK2 to one RS block. The FTL 370 set the physical address PA to an address of the RS block.

Thereafter, a merge operation is performed. The latest data DATA1″ corresponding to the first data DATA1 are programmed in the first page of the RS block BLK2. The latest data corresponding to the second data DATA2, that is, the update data DATA2″ are programmed in the second page PAGE3 of the RS block BLK2. Also, the latest data DATA3 corresponding to the third data DATA3 are programmed in the third page PAGE3 of the RS block BLK2. The FTL 370 stores information about the RS block BLK2 in the block mapping table and the RS block table 390.

Herein, the block mapping table may be defined as Table 2.

TABLE 2

| | Random | Random | | Physical Address | |
|---|---|---|---|---|---|
| Logical | Sequence | Sequence | Update | Block | Subblock |
| Address (LA) | Information | Block | Count | Number | Offset |
| Logical | 1 | 1 | 3 | 2 | |
| Block 1 | | | | | |
| Logical | 0 | 0 | 0 | | |
| Block 2 | | | | | |
| Logical | 0 | 0 | 0 | | |
| Block 3 | | | | | |
| Logical | 0 | 0 | 0 | | |
| Block 4 | | | | | |
| Logical | 0 | 0 | 0 | | |
| Block 5 | | | | | |
| Logical | 0 | 0 | 0 | | |
| Block 6 | | | | | |

The RS block table 390 may be defined as Table 3.

TABLE 3

| | | Logical Address | |
|---|---|---|---|
| Block Number | Page Offset | Offset | Invalid |
| 2 | 1 | 1 | |
| | 2 | 2 | |
| | 3 | 3 | |
| | 4 | | |
| | 5 | | |
| | 6 | | |

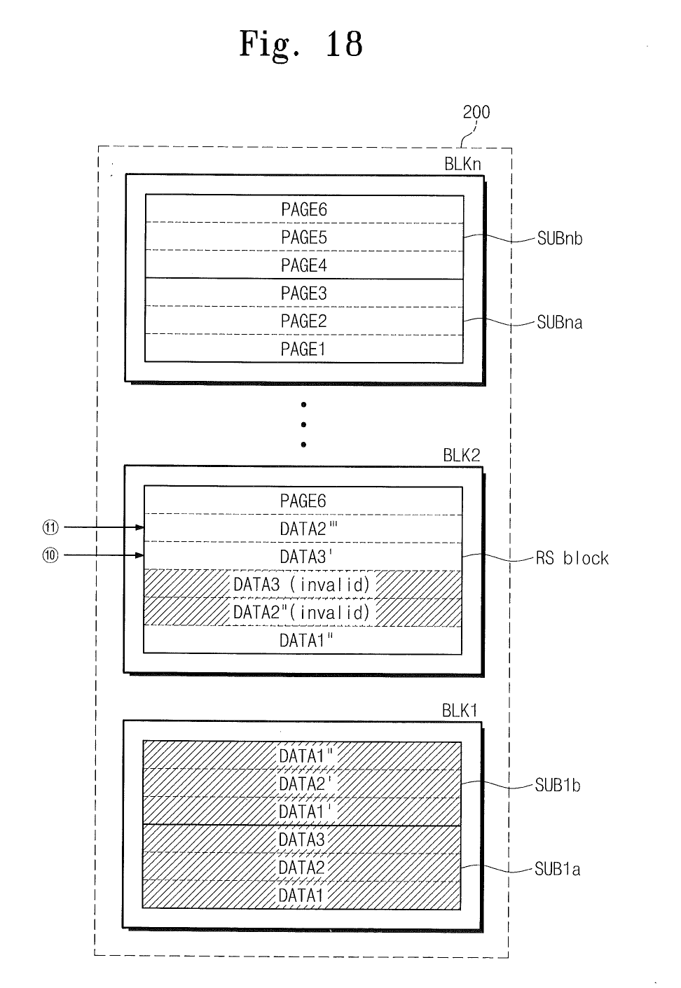

Referring to FIGS. 15 and 18, for example, it is assumed that an update request for the third data DATA3 is received from the host. Program data correspond to the RS block BLK2. Thus, the FTL 370 programs program data DATA3′ in the RS block BLK2 regardless of whether the program data are update data. Herein, because the program data DATA3′ are update data, the FTL 370 sets the previous data DATA3 corresponding to the program data DATA3′ to invalid data. The FTL 370 updates the RS block table 390.

For example, it is assumed that an update request for the second data DATA2″ is received from the host. Program data correspond to the RS block BLK2. Thus, the FTL 370 programs program data DATA2′″ in the RS block BLK2. Herein, the previous data DATA2″ corresponding to the update data DATA2′″ are set to invalid data. Herein, the RS block table 390 may be defined as Table 4.

TABLE 4

| | | Logical Address | |
|---|---|---|---|
| Block Number | Page Offset | Offset | Invalid |
| 2 | 1 | 1 | |
| | 2 | 2 | Invalid |
| | 3 | 3 | Invalid |
| | 4 | 3 | |
| | 5 | 2 | |
| | 6 | | |

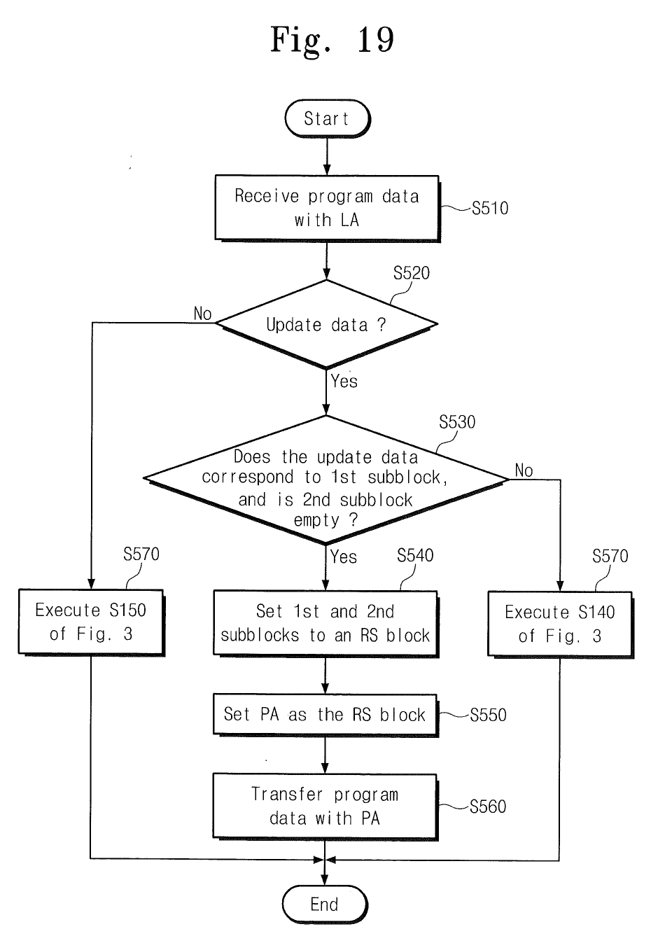

FIG. 19 is a flow chart illustrating an embodiment 2 of the operation method of the FTL 370 of FIG. 14.

Referring to FIGS. 14 and 19, program data and a corresponding logical address LA are received in step S510. Step S510 is performed in the same way as step S120 of FIG. 3.

In step S520, the FTL 370 determines whether the program data are update data. Step S520 is performed in the same way as step S130 of FIG. 3. If the program data are not update data, step S570 is performed. In step S570, step S150 of FIG. 3 is performed. That is, the FTL 370 sets the physical address PA on the basis of the block mapping table. If the program data are update data, step S530 is performed.

In step S530, the FTL 370 determines whether a data block corresponding to the update data is a first subblock and a second subblock corresponding to the data block is a free block. If the above condition is not satisfied, step S570 is performed. In step S570, the FTL 370 performs an update process described with reference to step S140 of FIG. 3.

If the above condition is satisfied (in step S530), step S540 is performed. In step 540, the FTL 370 sets the first and second storage regions of the memory block corresponding to the update data to one RS block. Herein, the FTL 370 stores information about the RS block in the RS block table 390. The RS block is managed in the same way as the RS block described with reference to FIGS. 15 to 18.

In step S550, the FTL 370 sets the physical address PA to an address of the RS block. In step S560, the FTL 370 transfers the program data and the physical address PA to the flash memory device 200.

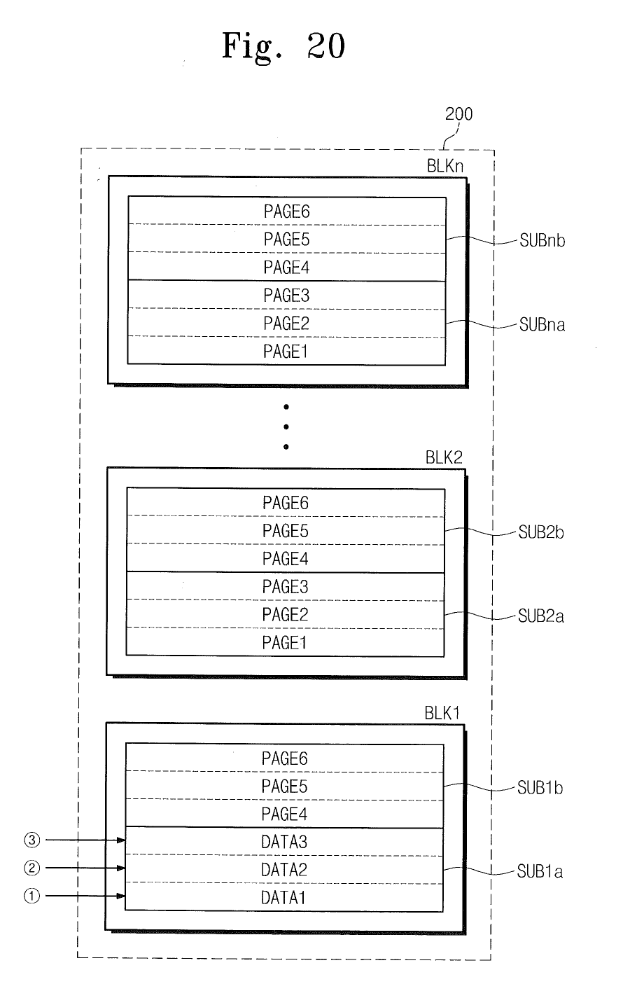

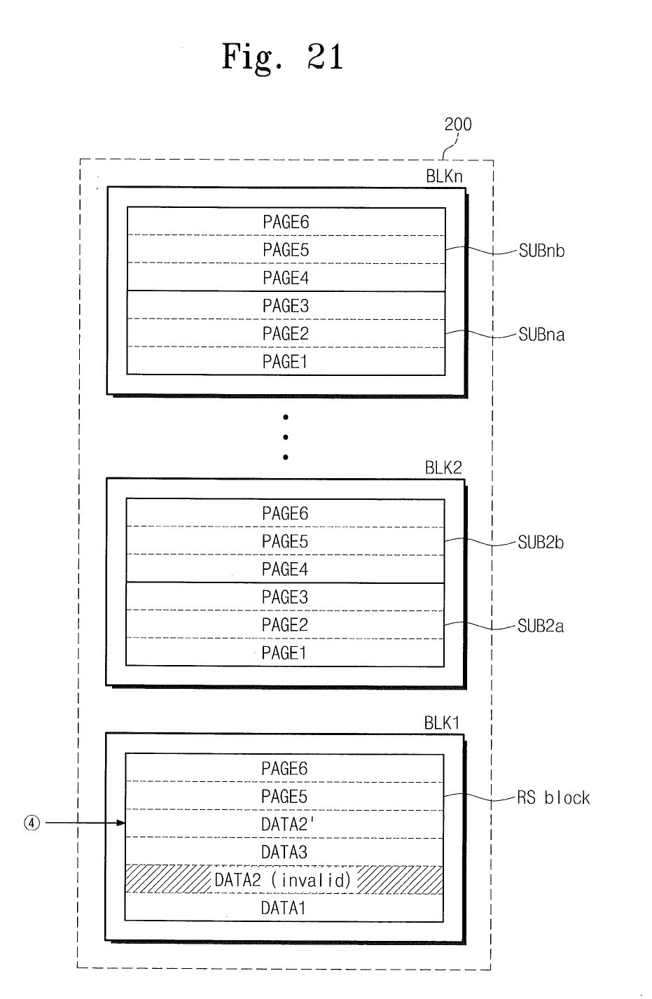

FIGS. 20 and 21 are block diagrams illustrating an embodiment of the operation method described with reference to FIG. 19.

Referring to FIGS. 19 and 20, for example, it is assumed that a program request for the first to third data DATA1˜DATA3 is received from the host. Also, it is assumed that the first to third data DATA1˜DATA3 correspond to the same logical block.

The FTL 370 sets one of the free subblocks as a data block. For example, it is assumed that the FTL 370 sets the first free subblock SUB1a of the first memory block BLK1 to a data block. The first to third data DATA1˜DATA3 are programmed in the data block SUB1a. Herein, the block mapping table may be defined as Table 5.

TABLE 5

| | | Physical Address | |
|---|---|---|---|
| Logical Address | Random Sequence | | Subblock |
| (LA) | Block | Block Number | Offset |
| Logical Block 1 | 0 | 1 | a |
| Logical Block 2 | 0 | | |
| Logical Block 3 | 0 | | |
| Logical Block 4 | 0 | | |
| Logical Block 5 | 0 | | |
| Logical Block 6 | 0 | | |

Referring to FIGS. 19 and 21, for example, it is assumed that an update request for the second data DATA2 is received from the host. In step S530, the FTL 370 determines whether a data block SUB1a is a first subblock and a second subblock corresponding to the data block is a free block. For example, it is assumed that the second subblock SUB1b of the first memory block BLK1 is a free subblock.

In step 540, the FTL 370 sets the first and second subblocks SUB1a and SUB1b to one RS block. Also, the FTL 370 generates a RS block table 390. The RS block table 390 is generated with reference to the block mapping table. The page offset of the data block is equal to the logical address offset of the corresponding logical block. Thus, the RS block table 390 may be generated on the basis of the block mapping table. The RS block table 390 may be defined as Table 6.

TABLE 6

| | | Logical Address | |
|---|---|---|---|
| Block Number | Page Offset | Offset | Invalid |
| 1 | 1 | 1 | |
| | 2 | 2 | |
| | 3 | 3 | |
| | 4 | | |
| | 5 | | |
| | 6 | | |

Also, the FTL 370 may update the block mapping table. The block mapping table may be defined as Table 7.

TABLE 7

| | | Physical Address | |
|---|---|---|---|
| Logical Address | Random Sequence | | Subblock |
| (LA) | Block | Block Number | Offset |
| Logical Block 1 | 1 | 1 | |
| Logical Block 2 | 0 | | |
| Logical Block 3 | 0 | | |
| Logical Block 4 | 0 | | |
| Logical Block 5 | 0 | | |
| Logical Block 6 | 0 | | |

Thereafter, the FTL 370 programs update data DATA2′ in the RS block. Also, the previous data DATA2 corresponding to the update data DATA2′ are set to invalid data. The FTL 370 updates the RS block table 390. The RS block table 390 may be defined as Table 8.

TABLE 8

| | | Logical Address | |
|---|---|---|---|
| Block Number | Page Offset | Offset | Invalid |
| 1 | 1 | 1 | |
| | 2 | 2 | Invalid |
| | 3 | 3 | |
| | 4 | 2 | |
| | 5 | | |
| | 6 | | |

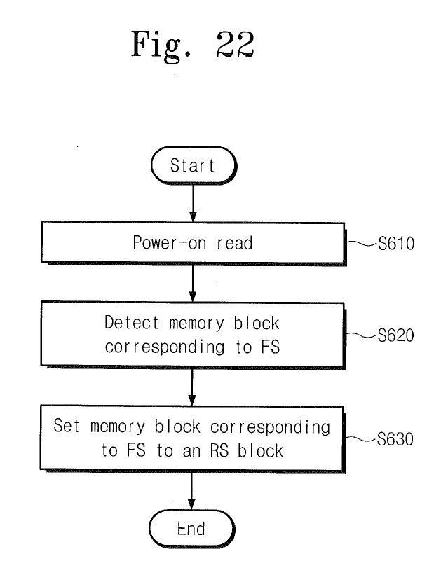

FIG. 22 is a flow chart illustrating an embodiment 3 of the operation method of the FTL 370 of FIG. 14.

Referring to FIGS. 14 and 22, a power-on read operation is performed in step S610. Herein, the FTL 370 is loaded into the controller 100 of FIG. 1.

In step 620, the FTL 370 detects a memory block corresponding to a file system (FS). For example, the FTL 370 detects a memory block corresponding to a file allocation table (FAT). When the flash memory device 200 is formatted in an FAT mode, the 0^{th} sector of the flash memory device 200 is set to a master boot record (MBR) or a partition boot sector (PBS). That is, the FTL 370 accesses the 0^{th} sector of the flash memory device 200 to detect the memory blocks storing the FS.

In step S630, the FTL 370 sets the first and second subblocks of the memory block corresponding to the FS to one RS block. The RS block is managed in the same way as the RS block described with reference to FIGS. 15 to 21. The FTL 370 generates an RS block table 390.

For example, when the flash memory device 200 is formatted, the FTL 370 programs the FS in the first subblocks SUB1a, SUB2a and SUBna of the memory blocks BLK1˜BLKn.

For example, when a merge operation is generated due to the update of the FS, the FTL 370 sets one of the memory blocks with the first and second free subblocks to one free RS block. Also, the latest data of the FS copied into the free RS block.

For example, the operation method of FIG. 22 and the operation method of FIGS. 15 to 18 may be performed in combination. That is, the FTL 370 sets the memory blocks corresponding to the FS to RS blocks. Also, when the data update count value of a specific logical block is greater than a reference value, the FTL 370 merges data of the specific logical block into the RS block.

For example, the operation method of FIG. 22 and the operation method of FIGS. 19 to 21 may be performed in combination. That is, the FTL 370 sets the memory blocks corresponding to the FS to RS blocks. Also, when specific data are updated, the FTL 370 sets the first and second subblocks corresponding to the specific data to one RS block.

It has been assumed in FIG. 22 that the FS is an FAT. However, the FS is not limited to being an FAT. For example, the FS may be one of various file systems such as FAT, FAT32, NTFS, HFS, JSF2, XFS, ODS-5, UDF, ZFS (Unix File System), ext2, ext3, ext4, ReiserFS, Reiser4, ISO 9660, Gnome VFS, BFS, and WinFS.

As described above, the access method for the flash memory device 200 according to an embodiment of the inventive concept includes dividing each of the memory blocks of the flash memory device 200 into at least two subblocks for management.

Thus, the number of log blocks increases. For example, it is assumed that the number of log blocks of the flash memory device 200 is limited to 4 memory blocks. If one memory block is divided into two subblocks for management, the number of log blocks is limited to 8 subblocks. That is, if one memory block is divided into two subblocks, the number of log blocks increases by two times. If one memory block is divided into ‘n’ subblocks, the number of log blocks increases by ‘n’ times. If the number of log blocks increases, the occurrence frequency of the merge/garbage collection decreases. Thus, the access time of the flash memory device 200 decreases.

Also, if one memory block is divided into two subblocks, the amount of data stored in one data block or log block decreases by ½. If one memory block is divided into ‘n’ subblocks, the amount of data stored in one data block or log block decreases by 1/n. That is, the amount of data copied in merge/garbage collection decreases. Thus, the merge/garbage collection time, i.e., the access time of the flash memory device 200 decreases.

As described above, the FTL 370 sets a free data block or a free log block on the basis of the first to third conditions. Thus, the discard of a free capacity is minimized.

As described above, the FTL 370 programs data of a logical block, the update count value of which reaches the reference value, in an RS block. Alternatively, the FTL 370 sets a memory block corresponding to updated data to an RS block. In the RS block, program data are sequentially programmed regardless of whether they are update data. Also, the RS block has a larger capacity than the subblock. Thus, the number of times of a merger operation can be prevented from increasing due to data of a high update frequency.

Also, when data of the RS block are updated, a log block is not separately allocated. Thus, the time to taken to allocate the log block is removed. When data of the RS block are merged, the data are processed on the basis of the RS block table corresponding to the RS block. Because an operation of determining the latest data on the basis of the block mapping table and the RS block table is removed, the merge/garbage collection time can be reduced.

As described above, the FTL 370 sets a memory block corresponding to an FS to an RS block. The FS has a higher update frequency than user data. According to the inventive concept, the time delay due to the merge/garbage collection of the FS is reduced.

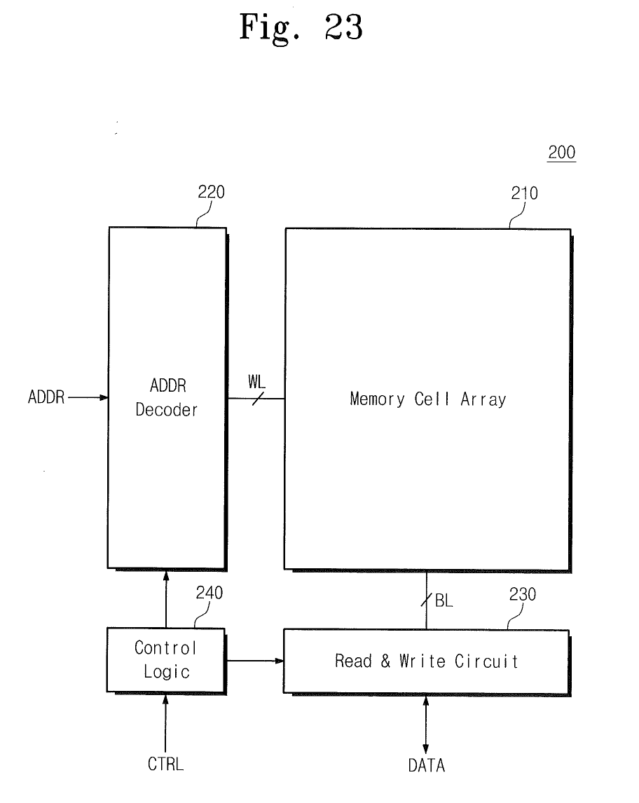

FIG. 23 is a block diagram illustrating the flash memory device 200 of FIG. 1.

Referring to FIG. 23, the flash memory device 200 includes a memory cell array 210, an address decoder 220, a read/write circuit 230, and a control logic circuit 240.

The memory cell array 210 is connected through word lines WL to the address decoder 220 and is connected through bit lines BL to the read/write circuit 230. The memory cell array 210 includes a plurality of memory cells. For example, the rows of the memory cells are connected to the word lines WL, and the columns of the memory cells are connected to the bit lines BL. For example, the memory cells are configured to store one or more bits per cell. The memory cell array 210 includes a plurality of memory blocks BLK1˜BLKn as described with reference to FIGS. 2 to 22.

The address decoder 220 is connected through the word lines WL to the memory cell array 210. The address decoder 220 operates in response to the control of the control logic circuit 240. The address decoder 220 receives an address ADDR from an external device. For example, the address ADDR is received from the controller 100 of FIG. 1.

The address decoder 220 decodes a row address among the received addresses ADDR to select the word lines WL. The address decoder 220 decodes a column address among the received addresses ADDR and transfers the same to the read/write circuit 230. For example, the address decoder 220 includes a row decoder, a column decoder, and an address buffer.

The read/write circuit 230 is connected through the bit lines BL to the memory cell array 210. The read/write circuit 230 operates in response to the control of the control logic circuit 250. The read/write circuit 230 exchanges data with an external device. For example, the read/write circuit 230 exchanges data with the controller 100 of FIG. 1.

The read/write circuit 230 receives the decoded column address from the address decoder 220 to select the bit lines BL.

For example, the read/write circuit 230 receives data from an external device and programs the received data in the memory cell array 210. The read/write circuit 230 reads data from the memory cell array 210 and outputs the read data to an external device. The read/write circuit 230 reads data from a first storage region of the memory cell array 210 and programs the read data in a second storage region of the memory cell array 210. For example, the read/write circuit 230 performs a copy-back operation.

For example, the read/write circuit 230 includes a page buffer, a column selection circuit, and a data buffer. As another example, the read/write circuit 230 includes a sense amplifier, a write driver, a column selection circuit, and a data buffer.

The control logic circuit 240 is connected to the address decoder 220 and the read/write circuit 230. The control logic circuit 240 controls an overall operation of the flash memory device 200. The control logic circuit 240 operates in response to a control signal CTRL received from an external device. For example, the control signal CTRL is received from the controller 100 of FIG. 1.

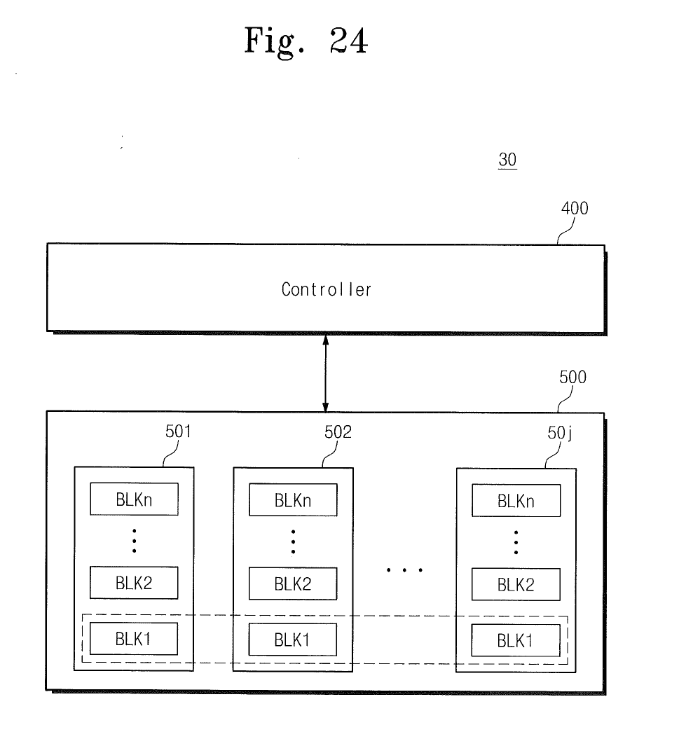

FIG. 24 is a block diagram illustrating an embodiment 2 of the memory system 10 of FIG. 1.

Referring to FIG. 24, a memory system 30 includes a controller 400 and a flash memory device 500. The controller 400 may be configured in the same way as the controller 100 of FIG. 1.

The flash memory device 500 includes a plurality of flash memory chips (or banks) 501˜50j. Each of the flash memory chips may be configured in the same way as the flash memory device 200 described with reference to FIGS. 1 to 23. The flash memory chips (or banks) 501˜50j may be configured to communicate with the controller 400 through a common channel. The flash memory device 500 may be configured to store a file translation layer (FTL). In a power-on read mode, the FTL stored in the flash memory device 500 may be loaded into the controller 400. The FTL loaded into the controller 400 may operate in the same way as the FTL 170 described with reference to FIGS. 2 to 13. Also, the FTL loaded into the controller 400 may operate in the same way as the FTL 370 described with reference to FIGS. 14 to 22.

The memory blocks of the flash memory chips (or banks) 501˜50j may form superblocks. For example, the first memory blocks BLK1 of the flash memory chips (or banks) 501˜50j may form a first superblock. The second memory blocks BLK2 of the flash memory chips (or banks) 501˜50j may form a second superblock. The n^{th} memory blocks BLKn of the flash memory chips (or banks) 501˜50j may form an n^{th} superblock.

The controller 400 may manage each of the superblocks as one memory block. For example, the FTL 170/370 may divide each of the superblocks into at least two sub-superblocks for management.

In a merge/garbage collection mode, the amount of data copied from the superblock is larger than the amount of data copied from one memory block. Thus, the merge/garbage collection time of the superblock is longer than the merge/garbage correction time of the memory block. The use of the embodiments described with reference to FIGS. 2 to 23 reduces the merge/garbage collection time, thus making it possible to compensate for the merge/garbage collection time delay caused by the formation of the superblock.

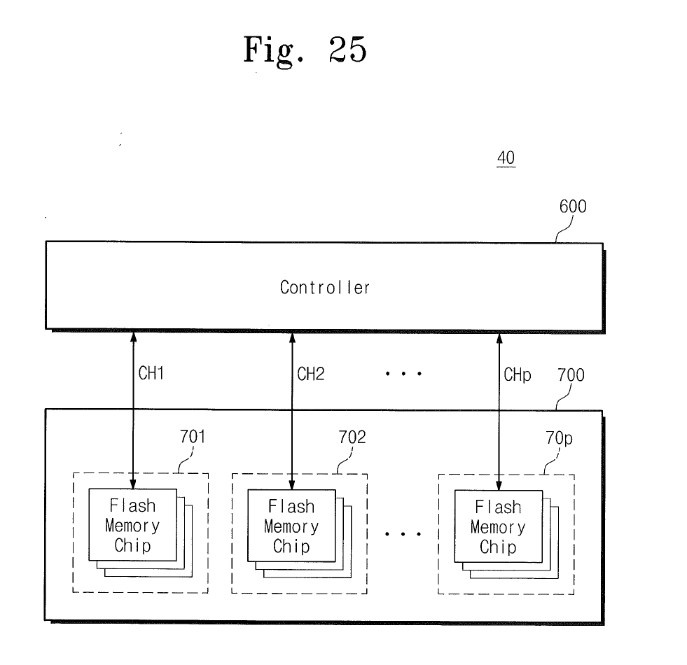

FIG. 25 is a block diagram illustrating an embodiment 3 of the memory system 10 of FIG. 1.

Referring to FIG. 25, a memory system 40 includes a controller 600 and a flash memory device 700. The controller 600 may be configured in the same way as the controller 100 of FIG. 1.

The flash memory device 700 includes a plurality of flash memory chip groups 701˜70p. Each of the flash memory chip groups includes a plurality of flash memory chips. Each of the flash memory chip groups is configured to communicate with the controller 600 through a common channel. Each of the flash memory chip groups may be configured in the same way as the flash memory device 500 described with reference to FIG. 24.

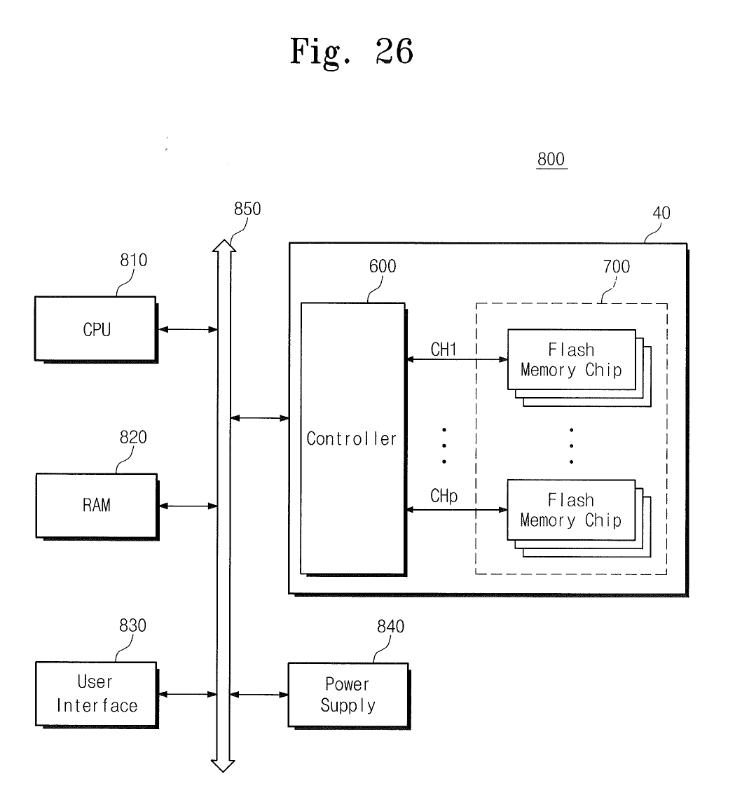

FIG. 26 is a block diagram of a computing system 800 including the memory system 40 described with reference to FIG. 25.

Referring to FIG. 26, a computing system 800 according to an embodiment of the inventive concept includes a central processing unit (CPU) 810, a random access memory (RAM) 820, a user interface 830, a power supply unit 840, and a memory system 40.

The memory system 40 is electrically connected through a system bus 850 to the CPU 810, the RAM 820, the user interface 830 and the power supply unit 840. Data, which are provided through the user interface 830 or processed by the CPU 810, are stored in the memory system 40. The memory system 40 includes a controller 600 and a flash memory device 700.

When the memory system 40 is provided for a solid state drive (SSD), the booting speed of the computing system 800 may increase remarkably. Although not illustrated in FIG. 26, those skilled in the art will readily understand that the computing system 800 may further include an application chipset and a camera image processor.

It has been described in the above embodiment that the computing system 800 includes the memory system 40 of FIG. 25. However, it will be understood that the computing system 800 may include at least one of the memory system 10 of FIG. 1, the memory system 30 of FIG. 24 and the memory system 40 of FIG. 25. For example, at least one of the memory systems 10, 30 and 40 is connected to the system bus 850.

It has been illustrated in FIG. 26 that a device of a reference numeral 800 is a computing system including at least one of the memory systems 10, 30 and 40. However, the device 800 is not limited to being a computing system. The device 800 may be defined as a memory system that includes one of the flash memory devices 200, 500 and 700 and one of the controllers 100, 400 and 600. For example, the device 800 may be defined as a memory system that includes one of the controllers 100, 400 and 600 connected to the system bus 850 and one of the flash memory devices 200, 500 and 700 connected to one of the controllers 100, 400 and 600.

It has been illustrated in FIGS. 1 to 25 that the access operation of the flash memory device 200/500/700 is performed by the FTL 170/370. However, the access operation of the flash memory device 200/500/700 is not limited to being performed by the FTL 170/370. For example, the access operation of the flash memory device 200/500/700 may be performed by an operating system (OS) driven by the CPU 810.

According to the inventive concept described above, a memory block is divided into at least two subblocks, thus making it possible to provide a method for accessing a flash memory device with a reduced merge/garbage collection time and a memory system including the same.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

1.-2. (canceled)

3. A method for accessing a flash memory device, comprising:
setting first and second storage regions of a memory block of the flash memory device to free blocks; and
setting each of the first and second storage regions to a data block independently.

4. The method of claim 3, wherein the setting of the first and second storage regions to a data block independently comprises setting the first and second storage regions to a log block independently.

5. The method of claim 3, wherein the first and second storage regions of the memory block are simultaneously erased in an erase operation.

6. The method of claim 3, wherein the first storage region is program-inhibited when the second storage region is set to a data block.

7. The method of claim 3, wherein the second storage region is set to a data block when the first storage region is a data block including a free capacity.

8. The method of claim 7, further comprising setting the free capacity of the first storage region to a programmed capacity.

9. A memory system comprising:
a flash memory device including a plurality of memory blocks; and
a controller configured to control the flash memory device,
wherein the controller sets each of the first and second storage regions of each of the memory blocks to one of a free block and a data block independently.

10. The memory system of claim 9, wherein the controller erases the flash memory device by the memory block.

11. The memory system of claim 9, wherein
the controller selects the second storage region of the memory block corresponding to a first condition among the memory blocks when selecting a free block to be programmed with data, and
the first storage region of the memory block corresponding to the first condition is one of a full block and an invalid block and the second storage region is a free block.

12. The memory system of claim 9, wherein
the controller selects the first storage region of the memory block corresponding to a second condition among the memory blocks when selecting a free block to be programmed with data, and
the first and second storage regions of the memory block corresponding to the second condition are free blocks.

13. The memory system of claim 9, wherein
the controller selects the second storage region of the memory block corresponding to a third condition among the memory blocks when selecting a free block to be programmed with data, and
the first storage region of the memory block corresponding to the third condition includes a free capacity and the second storage region is a free block.

14. The memory system of claim 13, wherein the controller sets the free capacity of the first storage region of the memory block corresponding to the third condition to a programmed capacity.

15. The memory system of claim 9, wherein when the second storage region of one of the memory blocks is set to a data block, the controller sets the first storage region of the one of the memory blocks to a program inhibition block.

16. The memory system of claim 9, wherein
when the update frequency of specific data is greater than a predetermined value, the controller sets the first and second storage regions of the memory block corresponding to a fourth condition among the memory blocks to a random sequence block and copies the specific data into the random sequence block, and
the first and second storage regions of the memory block corresponding to the fourth condition are free blocks.

17. The memory system of claim 9, wherein when first data programmed in one of the first storage regions of the memory cells are updated into second data, the controller sets the one of the first storage regions and the second storage region corresponding to the one of the first storage regions to a random sequence block and programs the second data in the random sequence block.

18. The memory system of claim 9, wherein the controller sets the first and second storage regions of one of the memory blocks, which stores a file system, to a random sequence block.

19. The memory system of claim 9, wherein the controller sets each of the first and second storage regions of each of the memory blocks to a log block independently.

20. The memory system of claim 9, wherein the flash memory device and the controller constitute a solid state drive (SSD).

21. The memory system of claim 9, further comprising a user interface configured to exchange information with a user.

22. A memory system comprising:
a flash memory device including a plurality of memory blocks; and
a controller configured to control the flash memory device,
wherein the controller divides each of the memory blocks into at least two sub storage regions and sets each of the sub storage regions to one of a free block and a data block independently.
